(19) United States
(12) Patent Application Publication
(10) Pub. No.: US 2011/0036799 A1
(43) Pub. Date: Feb. 17, 2011

(54) Lifting Assemblies Including Trapezoidal Strong Back Beam Systems

(76) Inventor: Douglas McGregor McKay, Norlane (AU)

Correspondence Address: HOWARD & HOWARD ATTORNEYS PLLC, 450 West Fourth Street, Royal Oak, MI, 48067, US

(21) Appl. No.: 12/744,253

(22) PCT Filed: Nov. 24, 2008
(86) PCT No.: PCT/AU08/01731

§ 371 Date: Aug. 6, 2010

(30) Foreign Application Priority Data
Nov. 22, 2007 (AU) 2007906386
Jul. 8, 2008 (AU) 2008903491

(51) Int. Cl. B66C 9/10; B66C 17/00; B66C 19/00

(52) U.S. Cl. 212/312

(57) ABSTRACT

Bridge crane assemblies, trapezoidal strong back beam systems and carriages for bridge crane assemblies are disclosed. According to some embodiments, a bridge crane assembly comprises a trapezoidal beam and a bridge attachable to an underside of the trapezoidal beam. The bridge comprises an attachment means for supporting a lifting device for the crane assembly. At least one guide track is attachable to a support structure and at least one carriage is longitudinally movable along the at least one guide track. Each carriage comprises a pair of spaced apart mounting plates and a plurality of rollers rotatably mounted to the mounting plates in a substantially vertical orientation. An axle extends between and is pivotally secured to the mounting plates. A displacement arm has a first end pivotally coupled to the axle and at least one second end for pivotal connection to the bridge.

### FIELD OF THE INVENTION

The present invention relates to lifting assemblies, and in particular, but not limited to, trapezoidal strong back beam systems, for use in connection with manual bridge cranes. The present invention also relates to carriages for bridge cranes. The trapezoidal strong back beam system has particular utility in connection with manually operated suspended bridge crane assemblies and lifting devices. However, it will be appreciated that the present invention has broader application and is not limited to that particular use.

### BACKGROUND OF THE INVENTION

Trapezoidal strong back beam systems are desirable for bridge crane designs because they allow for the bridge weight to be reduced compared with using rectangular hollow section (RHS) structural beams.

The use of trapezoidal beams is known in the prior art. For example: U.S. Pat. No. 6,868,646; U.S. Pat. No. 6,574,818; U.S. Pat. No. 2,336,622; U.S. Pat. No. 5,426,906; U.S. Pat. No. 6,189,854; U.S. Pat. No. 1,552,474; U.S. Pat. No. 4,610,117; U.S. Pat. No. 2,367,291; and U.S. Pat. No. 3,708,937.

Existing suspended crane assemblies generally include a crane, which is suspended from a trolley that is, in turn, suspended from at least one bridge. The trolley is capable of longitudinal movement along the at least one bridge. The at least one bridge is movably supported at either end from a pair of parallel tracks or guides. The tracks or guides are generally mounted to a building ceiling or roof structure. Alternatively, the tracks or guides (hereinafter referred to simply as “guides”) could be supported from a steel superstructure. This is a particularly attractive option in situations where the building ceiling or roof structure concerned is not designed to bear loads.

One problem with existing suspended crane assemblies and bridge beams is that they do not allow for the design of bridges with reduced weight and with comparable strength to RHS beams or other standard structural beams. Reducing the weight of the bridges would allow for easier installation and operation and reduce the overall cost of manufacture. Additionally, the reduced weight of the bridges would reduce the stress and load on the structure to which the trapezoidal strong back beam system is attached.

While the above-described devices fulfill their respective, particular objectives and requirements, the aforementioned patents do not describe a trapezoidal strong back beam system that allows for reduced weight of manually operated suspended bridge crane assemblies.

Therefore, a need exists for a new and improved trapezoidal strong back beam system that can be used for manually operated suspended bridge crane assemblies.

Another problem with existing manually operated bridge crane assemblies, and not just those with trapezoidal beams, occurs when an operator attempts to initiate movement of the bridge in either direction relative to the guides. The effort required to initiate such movement is often considerable, at least in part owing to the fact that movement of the other end of the bridge is initiated. This can cause the bridge to twist relative to the stationary guides, and thereby jam and prevent further movement. Furthermore, with existing assemblies, the guides must be aligned parallel or very close to parallel during installation, otherwise the bridge tends to jam in the guides preventing further movement.

The aforementioned jamming problems have been addressed to an appreciable extent with the inventor's crane assembly as disclosed in International Patent Application Publication No. WO 03/101878. However, this crane assembly is only applicable to specific bridge crane designs and includes some limitations. For example, the under slung bridge of the crane assembly limits the head room available in the environment in which the crane assembly is installed.

### OBJECT OF THE INVENTION

It is a preferred object of the present invention to provide a new and improved crane assembly that avoids, or at least ameliorates, one or more of the aforementioned disadvantages of the prior art.

### SUMMARY OF THE INVENTION

The inventor has identified various modifications and improvements to his crane assembly such that embodiments of the present invention reside in an improved bridge crane assembly, an improved carriage for bridge crane assemblies and an improved bridge crane assembly comprising a trapezoidal strong back beam.

According to one aspect, embodiments of the present invention reside in a carriage for a bridge crane assembly, the carriage comprising:

a pair of spaced apart mounting plates;

a plurality of rollers rotatably mounted in a substantially vertical orientation to the mounting plates for longitudinal movement of the carriage along a respective guide track of the bridge crane assembly;

an elongate member extending between the mounting plates; and

a displacement arm pivotally coupled at a first end to the elongate member, the displacement arm having at least one second end for pivotal connection to a bridge, the bridge comprising an attachment means for supporting a lifting device of the bridge crane assembly.

The displacement arm may be pivotally coupled to a pivot post via a pivot post bearing, the pivot post extending from the elongate member.

The elongate member may be an axle pivotally secured to the mounting plates.

Suitably, the displacement arm is pivotally connected to a bridge sleeve for receiving one end of the bridge.

Suitably, the displacement arm comprises a pair of appendages, each appendage pivotally connected to the bridge sleeve by a fastener.

Preferably, at least one of the mounting plates comprises an aperture through which the bridge protrudes.

The respective guide track may be in the form of an I-beam and the carriage moves on top of one web of the 1-beam.

Preferably, some of the plurality of rollers are positioned on top of one web of the I-beam and some of the plurality of rollers are positioned underneath the web.

The carriage may further comprise one or more end rollers, each end roller abutting and capable of rolling along a respective edge of the web of the 1-beam.

Preferably, a pair of end rollers is rotatably mounted in a substantially horizontal orientation to each mounting plate.

The carriage may further comprise:

a second elongate member spaced apart from the elongate member, the second elongate member extending between the mounting plates; and

a second displacement arm pivotally coupled at a first end to the second elongate member, the displacement arm having at least one second end for pivotal connection to the bridge.

The second elongate member may be an axle pivotally secured to the mounting plates.

The carriage may further comprise a shoulder either side of the bridge at the end of the bridge, each shoulder pivotally connected to a respective displacement arm.

The underside of each shoulder may comprise a support for receiving a pair of fasteners for pivotal connection to a respective displacement arm.

The carriage may further comprise projections extending inwardly from the mounting plates adjacent the rollers to prevent derailment of the rollers from the guide track.

The mounting plates and the first and second elongate members may form part of a cast box.

The carriage may further comprise a first base member for mounting at least one anti-derailment member. The first base member may comprise a plurality of elongate apertures for variable mounting of the at least one anti-derailment member.

The carriage may further comprise at least one end base member for mounting one or more end rollers, each end roller abutting and capable of rolling along a respective edge of a web of an I-beam of the respective guide track.

The at least one end base member may comprise a plurality of elongate apertures for variable mounting of the one or more end rollers.

According to another aspect, embodiments of the present invention reside in a bridge crane assembly comprising:

a trapezoidal beam;

a bridge attachable to an underside of the trapezoidal beam, the bridge comprising an attachment means for supporting a lifting device; at least one guide track attachable to a support structure;

at least one carriage longitudinally movable along the at least one guide track, the carriage comprising:
a pair of spaced apart mounting plates;
a plurality of rollers rotatably mounted in a substantially vertical orientation to the mounting plates;
an axle extending between and pivotally secured to the mounting plates; and
a displacement arm pivotally coupled at a first end to the axle, the displacement arm having at least one second end for pivotal connection to the bridge.

Suitably, the trapezoidal beam has a top section, a first side rigidly secured to the top section and a second side rigidly secured to the top section opposite the first side, the first and second sides tapering inwardly toward each other from the top section to the guide track.

Alternatively, the top section has a first top section rigidly secured to the first side, and a second top section rigidly secured to the second side, wherein the first top section is rigidly secured to the second top section in a generally overlapping manner.

Suitably, at least part of the first side and/or at least part of the second side comprises a lattice structure.

The at least one carriage may be top running or under slung with respect to the guide.

Suitably, the bridge beam can be constructed with only the trapezoidal beam, wherein the trapezoidal beam features a first flange extending from a first beam opposite the top section and a second flange extending from a second beam opposite the top section, the first and second flanges orientated toward each other. The configuration of the first and second flanges and the first and second sides allow for a bridge crane component to be received therein.

Embodiments of the invention may also include a plurality of diaphragm stiffeners in the interior of the first and second sides.

According to a further aspect, embodiments of the present invention reside in a bridge crane assembly comprising:

a trapezoidal beam;

at least one guide track attachable to an underside of the trapezoidal beam;

at least one carriage longitudinally movable within the at least one guide track;

a bridge comprising an attachment means for supporting a lifting device;

at least one displacement arm having a first end pivotally connected to the at least one carriage and at least one second end pivotally connected to a bridge, the bridge comprising an attachment means for supporting a lifting device; and

a universal joint provided between the at least one displacement arm and the at least one carriage to absorb rotational and lateral motions of the bridge when a force is applied to the attachment means.

According to yet a further aspect, embodiments of the present invention reside in bridge crane assembly comprising:

a bridge having an attachment means for supporting a lifting device;

at least one guide track attachable to a support structure; and

at least one carriage as claimed in claim 1 longitudinally movable along the at least one guide track.

It is to be appreciated that the assembly does not include the lifting device, or part thereof. The inclusion of the lifting device in the discussion of the present invention is merely provided to define the context of the invention.

Further aspects of the present invention will become apparent from the following detailed description. Numerous features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways.

### BRIEF DESCRIPTION OF THE DRAWINGS

By way of example only, preferred embodiments of the invention will be described more fully hereinafter with reference to the accompanying drawings, wherein:

FIG. 1 is a perspective view of a trapezoidal strong back beam system in accordance with embodiments of the present invention.

FIG. 2 is a side view of the trapezoidal strong back beam system of FIG. 1.

FIG. 3 is a cross-sectional view of the trapezoidal strong back beam system taken along line 3 in FIG. 2.

FIG. 4 is a cross-sectional view of the trapezoidal strong back beam system taken along line 4 in FIG. 3.

FIG. 5 is a perspective view of an alternative embodiment of the trapezoidal strong back beam system in accordance with embodiments of the present invention.

FIG. 6 shows front views of alternative embodiments of the trapezoidal strong back beam system in accordance with embodiments of the present invention.

FIG. 7 is a perspective view of an alternative embodiment of the trapezoidal strong back beam system in accordance with embodiments of the present invention.

FIG. 8 is a partial cross-sectional view of the alternative embodiment of the trapezoidal strong back beam system illustrated in FIG. 7.

FIG. 9 is a partial cross-sectional view of the alternative embodiment of the trapezoidal strong back beam system taken along line 9 in FIG. 8.

FIG. 10 is a partial cross-sectional view of the alternative embodiment of the trapezoidal strong back beam system illustrated in FIG. 9.

FIG. 11 is a partial cross-sectional view of the alternative embodiment of the trapezoidal strong back beam system taken along line 11 in FIG. 9.

FIG. 12 is a partial cross-sectional view of an alternative embodiment of the trapezoidal strong back beam system illustrated in FIG. 11.

FIG. 13 is a perspective view of an alternative embodiment of the trapezoidal strong back beam system in accordance with embodiments of the present invention.

FIG. 14 is a partial cross-sectional view of the alternative embodiment of the trapezoidal strong back beam system taken along line 14 in FIG. 11.

FIG. 15 is a partial cross-sectional view of the alternative embodiment of the trapezoidal strong back beam system taken along line 15 in FIG. 14.

FIG. 16 is a perspective view of a further alternative embodiment of the trapezoidal strong back beam system in accordance with embodiments of the present invention.

FIG. 17 is an enlarged view of part of the trapezoidal strong back beam system shown in FIG. 16.

FIG. 18 is a side view of a further alternative embodiment of the trapezoidal strong back beam system in accordance with embodiments of the present invention.

FIG. 19 is a perspective view of another alternative embodiment of a crane assembly in accordance with embodiments of the present invention.

FIG. 20 is a plan view of the crane assembly shown in FIG. 19.

FIG. 21 is a side view of the crane assembly shown in FIG. 19.

FIG. 22 is an enlarged view of the crane assembly shown in FIG. 19.

FIG. 23 is an end view of the crane assembly shown in FIG. 19.

FIG. 24 is a perspective view of another alternative embodiment of a carriage for a crane assembly in accordance with embodiments of the present invention.

FIG. 25 is a rotated perspective view of a box of the carriage shown in FIG. 24.

FIG. 26 is a plan view of the box shown in FIG. 25.

The same reference numerals refer to the same parts throughout the various figures.

### DETAILED DESCRIPTION OF THE INVENTION

Referring now to the drawings a trapezoidal strong back beam system according to embodiments of the present invention are shown and generally designated by the reference numeral 10.

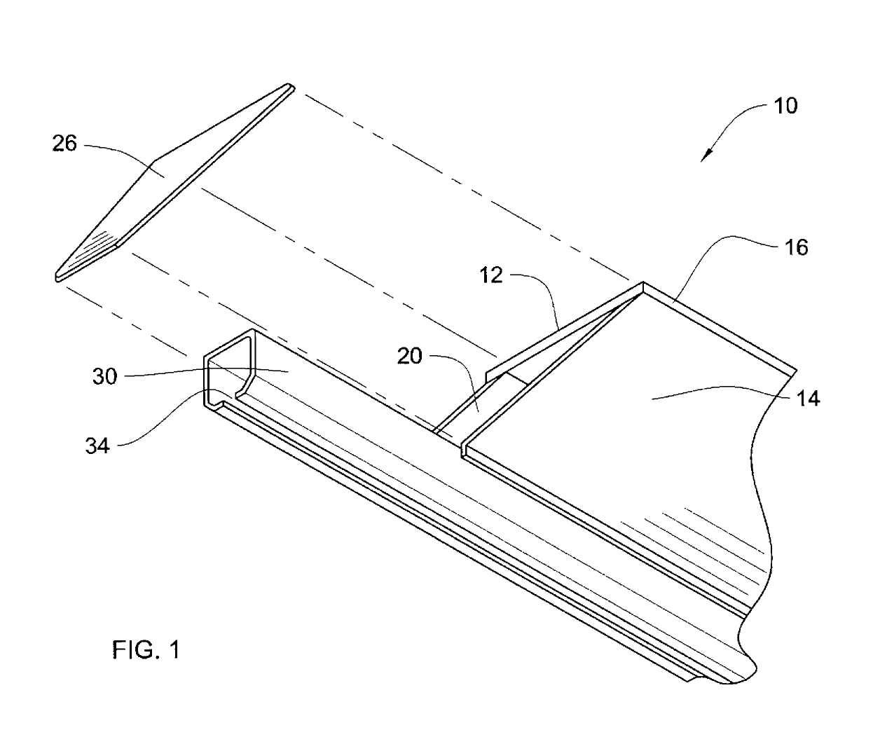

In FIG. 1, a new and improved trapezoidal strong back beam system 10 of the present invention for reducing the weight of bridge cranes is illustrated and will be described. More particularly, the trapezoidal strong back beam system 10 has a trapezoidal beam 12, a guide track 30, and an end cap 26. The trapezoidal beam 12 includes a first side 14, a second side 20 and a top section 16 adjacent the first and second sides 14, 20 that are rigidly secured to each other through means such as, but not limited to, welds along their edges or seams, rivets, fasteners, adhesives, or clamps. The guide track 30 is attached to the ends of the first and second sides 14, 20 opposite the overlapping top sections. The end cap 26 is attached to the first and second sides 14, 20 above the guide track 30, so as to cover the first and second sides 14, 20 and their overlapping top sections.

The guide track 30 has an opening 34 and is in the form of an open channel beam, preferably a C-section beam. The guide track 30 and opening 34 are adapted to receive a bridge crane component. The guide track 30 is made of a metal, but any other material having similar strength can be used, such as composites, or alloys.

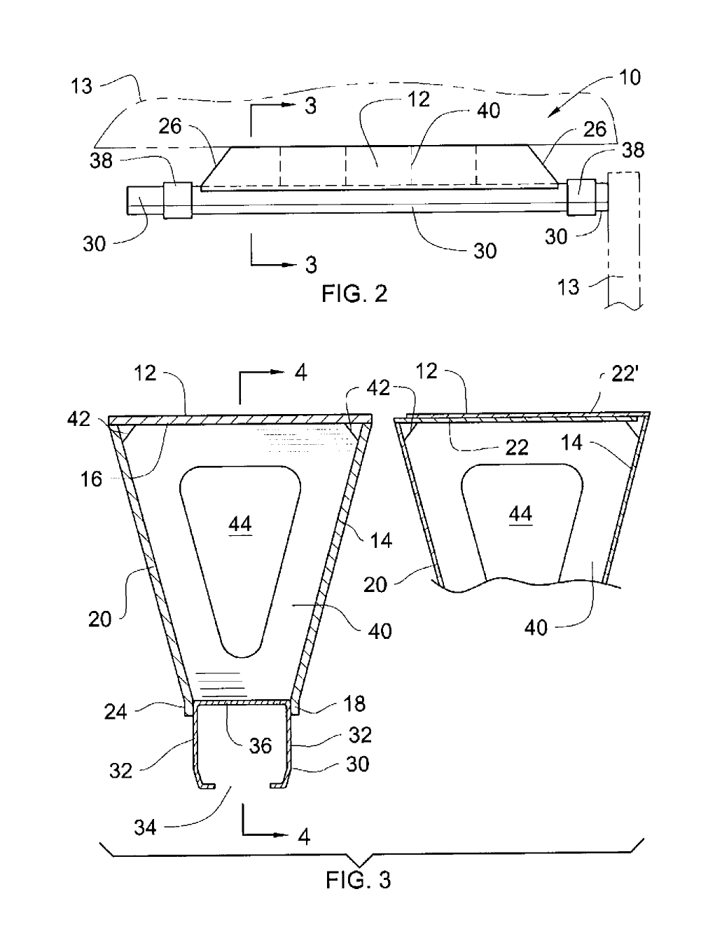

As illustrated in FIG. 2, the trapezoidal beam 12 has a plurality of diaphragm stiffeners 40 that are attached to the interior of the trapezoidal beam 12 and spaced incrementally along its longitudinal length. The trapezoidal beam 12 is attachable, preferably rigidly secured, to a support structure 13, which can be a building ceiling, roof, separate superstructure, or a support frame. The trapezoidal beam 12 is made of a metal, but any other material having similar strength can be used, such as composites, or alloys.

The guide track 30 can extend past the trapezoidal beam 12 so as to be able to connect to additional guide tracks 30 through a guide track coupler 38.

Referring now to FIG. 3, the trapezoidal beam 12 further includes a first flange 18 opposite the top section 16 of the first side 14, and a second flange 24 opposite the top section 16 of the second side 20. The top section 16 is rigidly secured to the first and second sides 14, 20 along their entire lengths. The first and second sides 14, 20 taper inwardly from the top section 16 to their respective flanges 18, 24. The angle at which the first and second sides 14, 20 taper relate to the height of the trapezoidal beam 12 and the width of the guide track 30.

Alternatively, as shown in FIG. 3, the trapezoidal beam 12 can include a first top section 22 adjacent the first side 14, a second top section 22′ adjacent the second side 20, a first flange 18 opposite the first top section 22 of the first side 14 and a second flange 24 opposite the second top section 22′ of the second side 20. The first and second top sections 22, 22′ are oriented parallel and adjacent to each other to produce a flush contact along their entire length. The first and second sides 14, 20 taper inwardly from their respective top sections 22, 22′ to their respective flanges 18, 24. The angle at which the first and second sides 14, 20 taper relate to the height of the trapezoidal beam 12 and the width of the guide track 30. The first top section 22 is placed above the second top section 22′ so as to leave a gap between the edges of the first and second top sections 22, 22′ and the first and second sides 14, 20, thereby allowing for the first and second top sections 22, 22′ to be rigidly fixed together, such as by, but limited to, welding along the first and second top sections 22, 22′ edges.

The guide track 30 has sides 32 and a top portion 36 adjacent to the sides 32, thereby producing an open channel beam. The first and second flanges 18, 24 extend down from the first and second sides 14, 20 to receive the sides 32 of guide track 30. The first and second flanges 18, 24 are rigidly fixed to the sides 32, such as by, but not limited to, welding along the first and second flanges 18, 24 edges.

The diaphragm stiffeners 40 are configured to correspond to the interior shape of the trapezoidal beam 12, thereby allowing the diaphragm stiffeners 40 to be securely inserted therein. The diaphragm stiffeners 40 each have chamfered top corners 42, and a centrally located opening 44. The chamfered top corners 42 are configured to receive the edge of the first or second top sections 22, 22′, depending on the orientation of the top sections. The bottom section of the diaphragm stiffeners 40 are configured to abut against the top portion 36 of the guide track 30. The diaphragm stiffeners 40 are rigidly fixed to the interior of the trapezoidal beam 12 and the top portion 36 of the guide track 30. It is to be appreciated that the diaphragm stiffeners 40 increase the strength and rigidity of the trapezoidal strong back beam system 10.

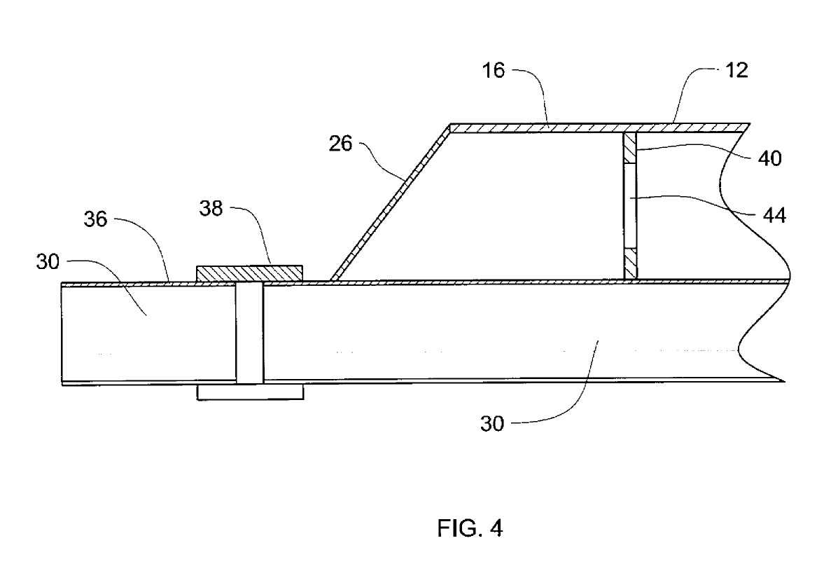

As best illustrated in FIG. 4, the guide track coupler 38 has a shape that corresponds to that of guide track 30 and which is larger so as to allow the guide track coupler 38 to slide over the guide track 30, thereby allowing an additional guide track 30 to be inserted in the free end of the guide track coupler 38, as best illustrated in FIGS. 2 and 4. The guide track coupler 38 is rigidly fixed to both ends of the guide tracks 30 inserted therein.

Additionally, the guide track coupler 38 can be configured to the shape of guide track 30, but which is smaller in size so as to allow the guide track coupler 38 to be inserted into two adjoining guide tracks 30 (not illustrated).

It is appreciated that the guide track 30, as described above, can be adapted to receive through the opening 34, a carriage, trolley, traveling crane, or any other traveling crane or bridge crane component.

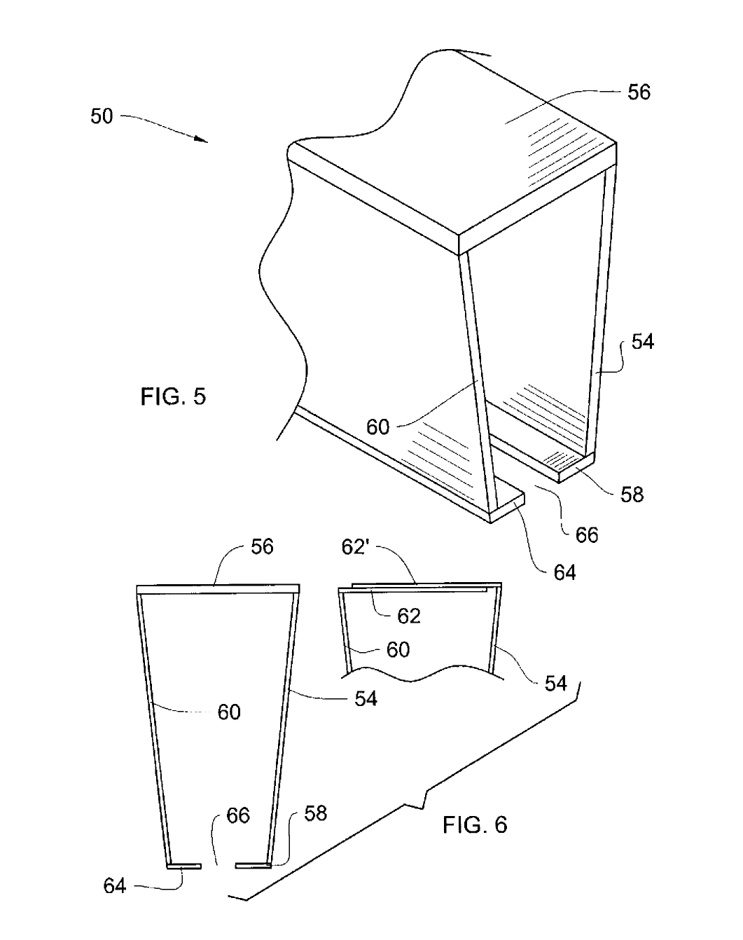

An alternative embodiment trapezoidal strong back beam system 50 is illustrated in FIG. 5. The alternative embodiment trapezoidal strong back beam system 50 has a first side 54, a second side 60, and a top section 56 that is rigidly secured to the first and second sides 54, 60 through means such as, but not limited to, welds along their flange seams, rivets, fasteners, adhesives, or clamps.

Alternatively, with additional reference to FIG. 6, the trapezoidal strong back beam system 50 can include a first top section 62 adjacent the first side 54, a second top section 62′ adjacent the second side 60, a first flange 58 opposite the first top section 62 of the first side 54, a second flange 64 opposite the second top section 62′ of the second side 60 and an opening 66 between the first and second flanges 58, 64. The first and second top sections 62, 62′ are oriented parallel and adjacent to each other to produce a flush contact along their entire length. The first top section 62 is placed above the second top section 62′ so as to leave a gap between the edges of the first and second top sections 62, 62′ and the first and second sides 54, 60, thereby allowing for the first and second top sections 62, 62′ to be rigidly fixed together, such as by, but limited to, welding along the edges of the first and second sides 54, 60.

Additionally, diaphragm stiffeners (not illustrated) can be inserted into the trapezoidal strong back beam system 50 in a way that leave a space between the bottom of the stiffener and the first and second flanges 58, 64.

The first and second flanges 58, 64 are angled inwardly toward each other. Preferably, the angle orientates the first and second flanges 58, 64 parallel with the top section 56, as best illustrated in FIG. 6. This first flange 58, second flange 64 and opening 66 configuration substantially produces a guide or track system adapted to receive a carriage, trolley, or traveling crane or bridge crane component.

The first and second sides 54, 60 taper inwardly from the top section 56 to their respective flanges 58, 64. The angle at which the first and second sides 54, 60 taper relate to the desired width of the opening 66.

It is appreciated that the alternative embodiment trapezoidal strong back beam system 50, as described above, produces a combination trapezoidal beam and guide track which can be adapted to receive through the opening 66, a carriage, trolley, traveling crane, or any other traveling crane or bridge crane component.

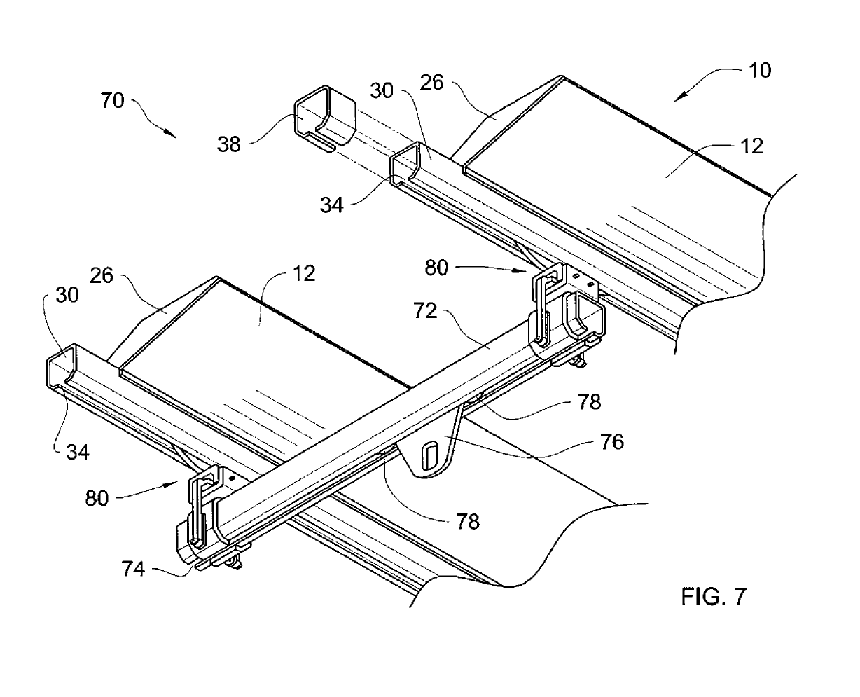

FIG. 7 illustrates another alternative embodiment trapezoidal strong back beam system 70, which includes a lifting assembly. A lifting device in the form of a manually operated crane (not illustrated) may be suspended from the lifting assembly by attachment means 76. The attachment means 76 could be a hook, chain or other suitable device. It is to be appreciated that the lifting device could adopt any suitable form. For example, the lifting device could be a manually or an electrically operated crane.

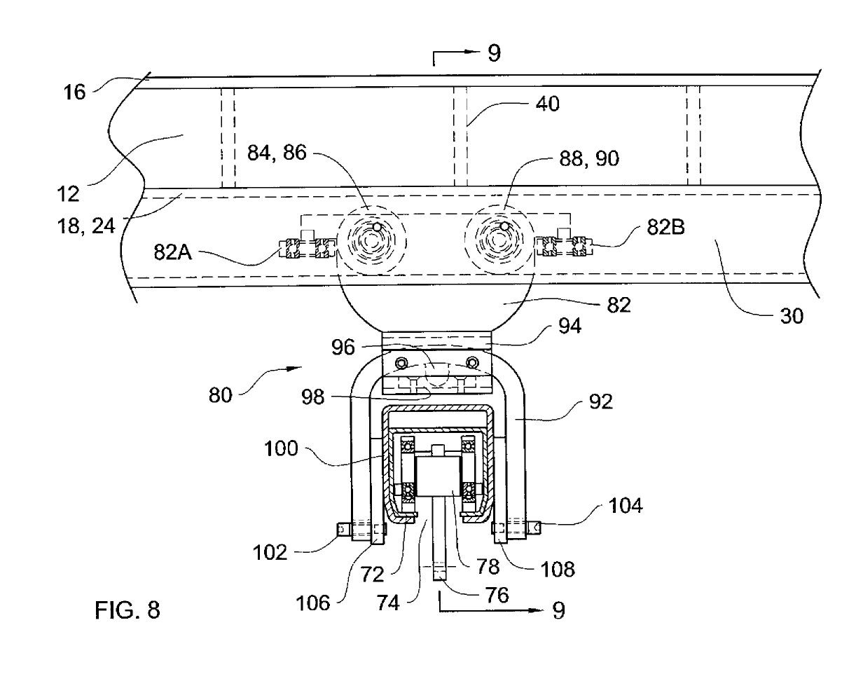

The attachment means 76 is connected to a trolley 78, which is illustrated in further detail, for example, in FIG. 8. The trolley 78 is movably suspended from a bridge 72, which can have a similar configuration to the guide track 30. Additionally, the bridge 72 could be in the form of an open channel section, an I-beam, or any other suitable form. The trolley 78 includes trolley rollers being wheels, ball bearings or other suitable propulsion means. The rollers are capable of rolling longitudinally along the bridge 72. The trolley rollers could adopt any suitable form. In this respect, the trolley rollers could include plastic coated rolling surfaces for silent running. Alternatively, the rollers, including the roller surfaces, could be constructed from steel. Alternatively, other mechanisms could be used in place of rollers, such that the trolley 78 is movable along the length of the bridge 72.

The attachment means 76 extends through an opening 74 provided in the underside of the bridge 72. In this way the attachment means 76 and crane are movable along the length of the bridge 72. Where the bridge 72 does not have a slot, the attachment means 76 is connected to the trolley 78 or bridge 72. It is to be appreciated that the attachment means 76 could be movably connected to two or more bridges 72.

As shown in FIG. 7, two substantially parallel trapezoidal strong back beam systems 10 are provided. The bridge 72 is movable longitudinally relative to the parallel guide tracks 30 of the trapezoidal strong back beam systems 10. In the illustrated embodiment, the bridge 72 is manually movable relative to the parallel guide tracks 30. However, it is to be appreciated that the bridge 72 could be electrically movable relative to the parallel guide tracks 30.

The parallel guide tracks 30 of the trapezoidal strong back beam systems 10 as shown are formed from an open channel C-section which are respectively provided with openings 34.

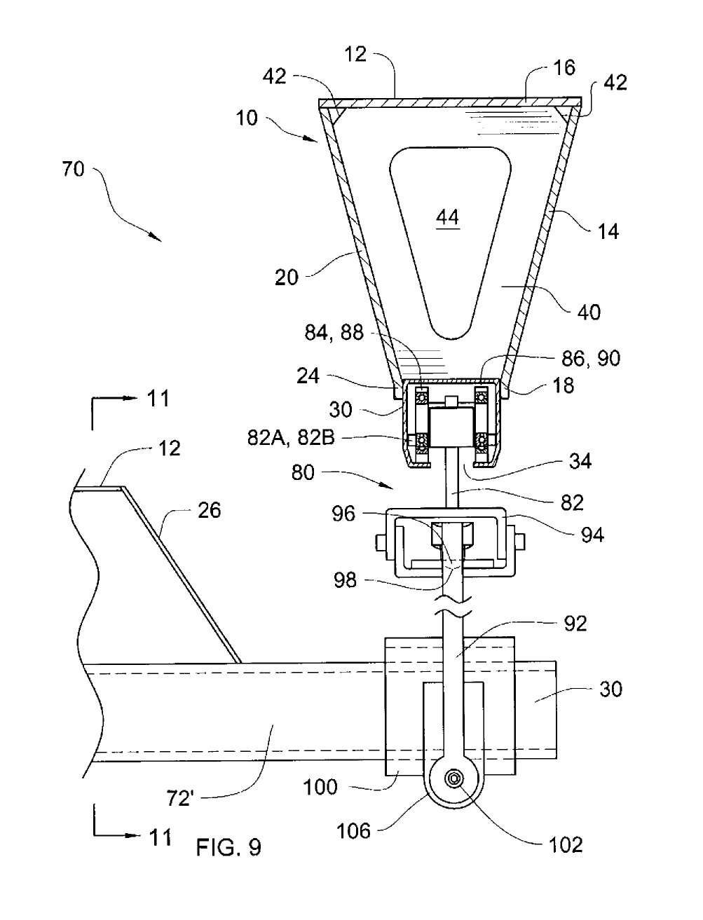

As best illustrated in FIG. 9, the parallel guide tracks 30 are each rigidly secured to the first and second flanges 18, 24 of the trapezoidal beams 12, thereby forming the trapezoidal strong back beam system 10 to which the lifting assembly is attached, thereby producing the alternative embodiment trapezoidal strong back beam system 70. The top section 16 of the trapezoidal beams 12 is then rigidly secured to a building ceiling, roof or separate superstructure. However, it is to be appreciated that the parallel guide tracks 30 could be provided with some movement relative to their mountings, if desired. End caps 26 are rigidly secured to the ends of the trapezoidal beams 12 so as to cover the first and second sides 14, 20 and the top section 16.

It can be appreciated the guide track couplers 38 can be attached to the ends of the guide tracks 30 to allow for the attachment of additional guide tracks 30 to the alternate embodiment trapezoidal strong back beam system 70.

The bridge 72 includes carriages 80, which are provided for traveling along a respective one of the parallel guide tracks 30. The relationship and configuration of the carriages 80 and the guide tracks 30 are substantially identical. Therefore, the following description, with reference to FIGS. 8 and 9, in part, refers only to one carriage 80 and guide track 30. Additionally, the carriages 80 can be motorized or provided with a motor and drive system.

The parallel guide tracks 30 of the trapezoidal strong back beam system 10 are illustrated in FIGS. 7, 8 and 9 as being open channels in profile and therefore include an internal track system. The trapezoidal beams 12 each include a plurality of diaphragm stiffeners 40 rigidly secured therein. It is to be appreciated, however, that the guide tracks 30 could adopt other suitable profiles, including I-beam (or external track) profiles (not illustrated).

The carriage 80, or similar device, is movable along the parallel guide tracks 30 of the trapezoidal strong back beam system 10 and includes at least one mounting plate 82. The mounting plate 82 is configured to travel longitudinally along the parallel guide track 30 by way of rollers 84, 86, 88, 90 which are rotatably mounted to the mounting plate 82. The carriages 80 bear the weight of the bridge 72 and the crane (not illustrated), which is, in turn, borne by the parallel guide tracks 30. An additional mounting plate 82 may be used external of the profile (I-beam).

Preferably, the rollers 84, 86, 88, 90 include tapered surfaces thereby enabling the rollers 84, 86, 88, 90 to roll efficiently along the guide tracks 30. The rollers 84, 86, 88, 90 include plastic (or rubber) coated rolling surfaces. The plastic coated rolling surfaces are provided to reduce rolling noise of the rollers 84, 86, 88, 90. It is to be appreciated, however, that the rollers 84, 86, 88, 90 need not include plastic coated rolling surfaces. The rollers 84, 86, 88, 90 could instead include, for example, steel rolling surfaces.

Furthermore, it is to be appreciated that the rollers 84, 86, 88, 90 could be replaced by another suitable arrangement such as, for example, a bearing arrangement.

Existing crane assemblies tend to jam when an operator initiates movement of the bridge along the assembly guides. This is, in part, a result of the rigid connection in existing crane assemblies of the bridge to the carriage.

To address this problem, the present invention includes a displacement arm 92. The displacement arm 92 is constructed from mild steel, or higher-grade steel, generally from steel plate or steel strip. Alternatively, the displacement arm 92 could be constructed from any other suitable material. The displacement arm 92 is pivotally connected to a sleeve 94. The sleeve 94 is rigidly fastened (by any suitable means) to the mounting plate 82. The mounting plate 82 is preferably welded to the sleeve 94, but other means of rigid attachment such as bolting could be used. The pivotal connection between the displacement arm 92 and the sleeve 94 is by way of a ball bearing 96. The ball bearing 96 is retained in place by a ball bearing seat 98 provided in the displacement arm 92 and the sleeve 94. The ball bearing 96 could be manufactured from any suitable grade of steel, or any other suitable material. The bearing seat is formed from a plastic, such as nylon, to minimize friction, but could be formed from other suitable materials.

The displacement arm 92 is pivotally connected to a bridge sleeve 100, as illustrated in FIGS. 8 and 9, which, in turn, is securely connected to one end of the bridge 72. The bridge sleeve 100 is constructed from steel. Any suitable grade steel, or any other material, could be used in the construction of the bridge sleeve 100. The displacement arm 92 is pivotally connected to the bridge sleeve 100 by two fasteners 102, 104 via displacement arm appendages 106, 108. The fasteners 102, 104 provide a pivotal connection between the displacement arm 92 and the bridge sleeve 100.

The above arrangement forms a universal joint that provides the necessary relative pivoting and lateral movement between the carriage 80 and the bridge 72 to at least reduce the incidence of jamming of the alternative embodiment trapezoidal strong back beam system 70, upon initiating movement of the bridge 72 relative to the parallel guide tracks 30 of the trapezoidal strong back beam systems 10.

It is to be appreciated that the pivotal connection of the carriages 80 to the bridge 72 could adopt configurations different to that specifically described above. The pivotal connection could instead, for example, include a rod end, or other pivotal or rotatable linkage arrangement.

The mounting plate 82 includes a safety mechanism in the form of anti-derailment means 82A, 82B. The anti-derailment means 82A, 82B are ball bearings or similar, which ensure the carriages 80 remain engaged with the guide tracks 30 of the trapezoidal strong back beam system 10. The anti-derailment means 82A, 82B are provided to prevent the bridge 72 and crane crashing to the ground in the event of failure of the rollers 84, 86, 88, 90 or other parts of the carriage 80.

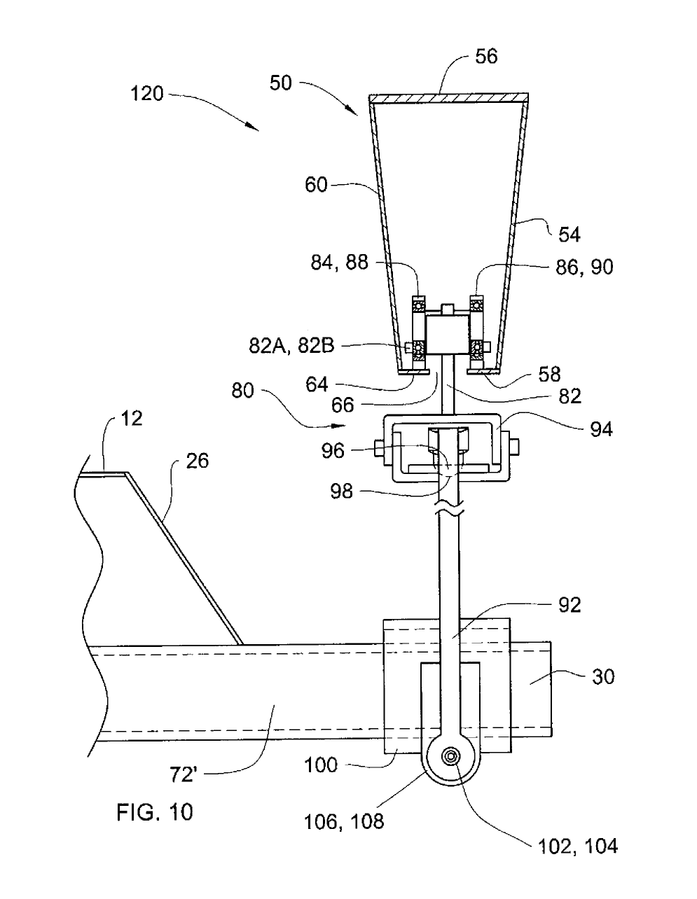

The bridge 72 and the parallel guide tracks 30 are formed from cold-rolled steel in tube or bar. It can also be appreciated that the bridge 72 can be in the form of trapezoidal beam system 10, 50, thereby forming a trapezoidal beam bridge 72′, as best illustrated in FIGS. 9 and 10. Bridge 72 can consist of trapezoidal beam 12, and guide track 30, wherein the portion of guide track 30 that extends past trapezoidal beam 12 is received in the bridge sleeve 100.

Reference is now made to FIG. 10, which illustrates another alternative embodiment trapezoidal strong back beam system 120. The alternative embodiment trapezoidal strong back beam system 120 is similar to the alternative embodiment trapezoidal strong back beam system 70 of FIG. 7 except that the parallel guide tracks 30 and the trapezoidal beams 12 of the alternative embodiment trapezoidal strong back beam system 70 are replaced with parallel alternative embodiment trapezoidal beams 50 of FIGS. 5 and 6.

The trapezoidal beam 50 has a first side 54, a top section 56, a first flange 58, a second side 60, and a second flange 64. The top section 56 is rigidly secured to the first and second sides 54, 60 through means such as, but not limited to, welds along their flange seams, rivets, fasteners, adhesives, or clamps.

The top section 56 is adjacent the first side 54 and the second side 60. The first flange 58 is opposite of the top section 56 of the first side 54, and the second flange 64 is opposite the top section 56 of the second side 60. An opening 66 is defined between the first and second flanges 58, 64.

The first and second flanges 58, 64 are angled inwardly toward each other. Preferably, the angle orientates the first and second flanges 58, 64 parallel with the top section 56, as best illustrated in FIG. 10.

The first and second sides 54, 60 taper inwardly from the top sections 56 to their respective flanges 58, 64. The angle at which the first and second sides 54, 60 taper relate to the desired width of the opening 66.

The bridge 72 includes carriages 80. The carriages 80 are provided for traveling along the first and second flanges 58, 64 of the alternate embodiment trapezoidal strong back beam system 50 respectively. The relationship and configuration of the carriages 80 and the first and second flanges 58, 64 are substantially identical. Therefore, the following description, with reference to FIG. 10, in part, refers only to one carriage 80 and the first and second flanges 58, 64 of a single alternative embodiment trapezoidal strong back beam system 50. Additionally, the carriages 80 can be motorized or provided with a motor and drive system.

The first and second flanges 58, 64 of the alternative embodiment trapezoidal strong back beam system 50 form an internal track system. The alternative embodiment trapezoidal strong back beam system 50 can each include a plurality of diaphragm stiffeners 40 rigidly secured therein (not illustrated). It is to be appreciated, however, that the first and second flanges 58, 64 could adopt other suitable profiles, including I-beam, or external track profiles (not illustrated).

The carriage 80, or similar device, is movable along the first and second flanges 58, 64 of the trapezoidal strong back beam system 50 and includes at least one mounting plate 82. The mounting plate 82 is configured to travel longitudinally along the first and second flanges 58, 64 by way of rollers 84, 86, 88, 90, which are rotatably mounted to the mounting plate 82. The carriages 80 bear the weight of the bridge 72 and the crane (not illustrated), which is, in turn, borne by the first and second flanges 58, 64 of the trapezoidal strong back beam system 50. An additional mounting plate 82 may be used external of the profile (I-beam).

Preferably, the rollers 84, 86, 88, 90 include tapered surfaces thereby enabling the rollers 84, 86, 88, 90 to roll efficiently along the first and second flanges 58, 64. The rollers 84, 86, 88, 90 include plastic (or rubber) coated rolling surfaces. The plastic coated rolling surfaces are provided to reduce rolling noise of the rollers 84, 86, 88, 90. It is to be appreciated, however, that the rollers 84, 86, 88, 90 need not include plastic coated rolling surfaces. The rollers 84, 86, 88, 90 could instead include, for example, steel rolling surfaces.

Furthermore, it is to be appreciated that the rollers 84, 86, 88, 90 could be replaced by another suitable arrangement such as, for example, a bearing arrangement.

Existing crane assemblies tend to jam when an operator initiates movement of the bridge along the assembly guides. This is, in part, a result of the rigid connection in existing crane assemblies of the bridge to the carriage.

To address this problem, this alternative embodiment of the present invention includes a displacement arm 82. The displacement arm 92 is constructed from mild steel, or higher-grade steel, generally from steel plate or steel strip. Alternatively, the displacement arm 92 could be constructed from any other suitable material. The displacement arm 92 is pivotally connected to a sleeve 94. The sleeve 94 is rigidly fastened (by any suitable means) to the mounting plate 82. The mounting plate 82 is preferably welded to the sleeve 94, but other means of rigid attachment such as bolting could be used. The pivotal connection between the displacement arm 92 and the sleeve 94 is by way of a ball bearing 96. The ball bearing 96 is retained in place by a ball bearing seat 98 provided in the displacement arm 92 and the sleeve 94. The ball bearing 96 could be manufactured from any suitable grade of steel, or any other suitable material. The bearing seat is formed from a plastic, such as nylon, to minimize friction, but could be formed from other suitable materials.

The displacement arm 92 is pivotally connected to a bridge sleeve 100, as illustrated in FIG. 10, which, in turn, is securely connected to one end of the bridge 72. The bridge sleeve 100 is constructed from steel. Any suitable grade steel, or any other material, could be used in the construction of the bridge sleeve 100. The displacement arm 92 is pivotally connected to the bridge sleeve 100 by two fasteners 102, 104 via displacement arm appendages 106, 108. The fasteners 102, 104 provide a pivotal connection between the displacement arm 92 and the bridge sleeve 100.

The above arrangement forms a universal joint that provides the necessary relative pivoting and lateral movement between the carriage 80 and the bridge 72 to at least reduce the incidence of jamming of the alternative embodiment lifting assembly 120, upon initiating movement of the bridge 72 relative to the first and second flanges 58, 64 of the alternate embodiment trapezoidal strong back beam system 50.

It is to be appreciated that the pivotal connection of the carriages 80 to the bridge 72 could adopt a configuration(s) different to that specifically described above. The pivotal connection could instead, for example, include a rod end, or other pivotal or rotatable linkage arrangement.

The mounting plate 82 includes a safety mechanism in the form of anti-derailment means 82A, 82B. The anti-derailment means 82A, 82B are ball bearings or similar, which ensure the carriages 80 remain engaged with the first and second flanges 58, 64 of the alternative embodiment trapezoidal strong back beam system 50. The anti-derailment means 82A, 82B are provided to prevent the bridge 72 and crane crashing to the ground in the event of failure of the rollers 84, 86, 88, 90 or other parts of the carriage 80.

It can also be appreciated that the bridge 72 can be in the form of trapezoidal beam system 10, 50, thereby forming a trapezoidal beam bridge 72′. Bridge 72 can consist of trapezoidal beam 12, and guide track 30, wherein the portion of guide track 30 that extends past trapezoidal beam 12 is received in the bridge sleeve 100.

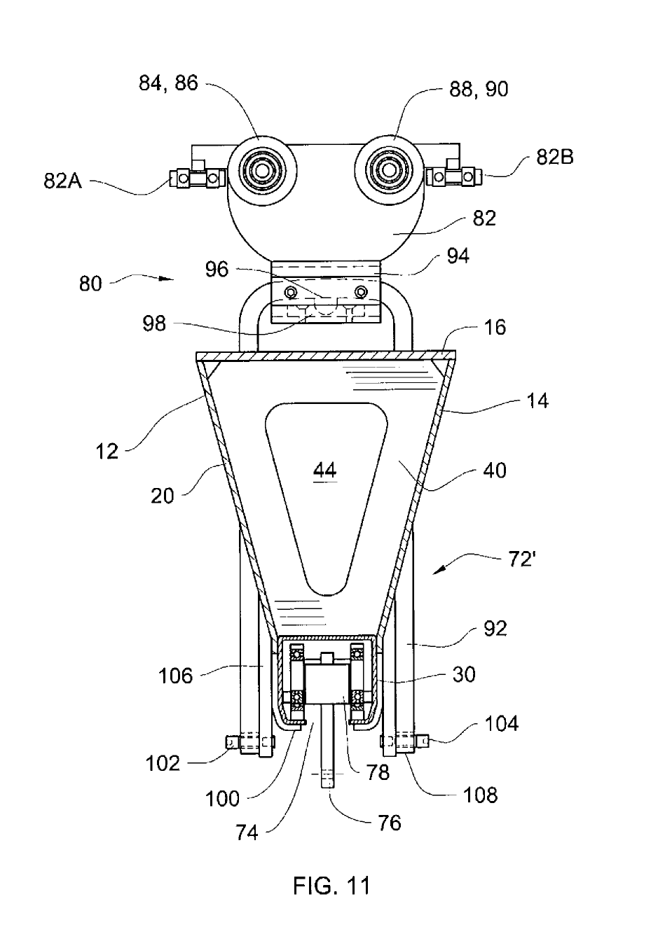

Referring now to FIG. 11 which illustrates the alternative embodiment of the trapezoidal strong back beam system 70 having the bridge 72 consisting of the trapezoidal beam 12 and guide track 30, thereby forming a trapezoidal beam bridge 72′. All the elements and their functions of the above-described trapezoidal strong back beam system 70 are incorporated herein to the alternative embodiment illustrated in FIG. 11.

The trapezoidal beam bridge 72′ consists of the trapezoidal beam 12 and the guide track 30, including all their structural elements as described above.

The displacement arm 92 can be modified to accommodate the trapezoidal beam bridge 72′ therein. The displacement arm 92 is pivotally connected to a bridge sleeve 100, as illustrated in FIG. 11, which, in turn, is securely connected to the guide track 30 of the trapezoidal beam bridge 72′. The bridge sleeve 100 is constructed from steel. Any suitable grade steel, or any other material, could be used in the construction of the bridge sleeve 100. The displacement arm 92 is pivotally connected to the bridge sleeve 100 by two fasteners 102, 104 via displacement arm appendages 106, 108. The fasteners 102, 104 provide a pivotal connection between the displacement arm 92 and the bridge sleeve 100. The displacement arm 92, sleeve 94 and carriage 80 are identical to that described above in FIGS. 8-10.

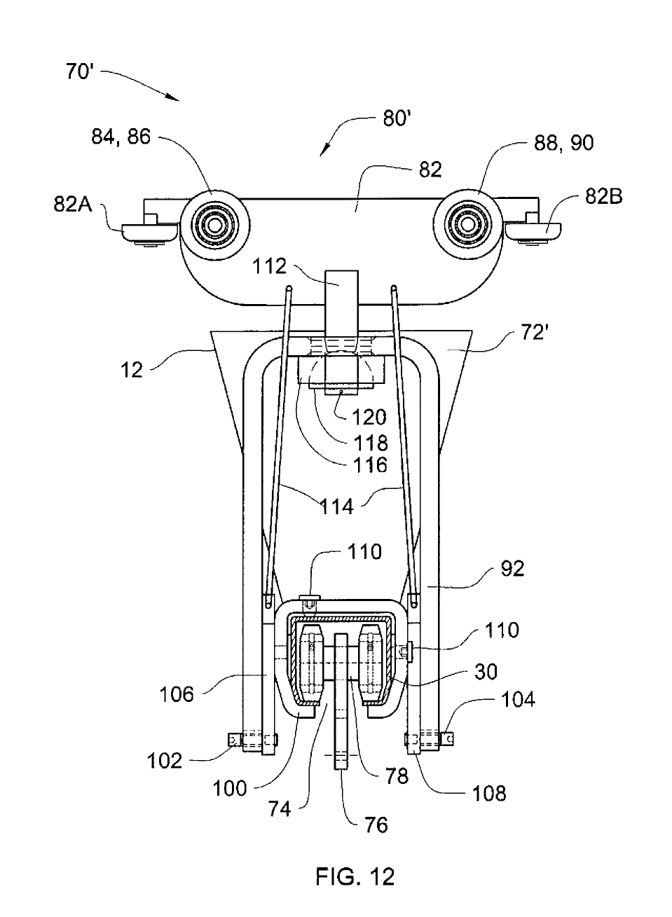

Referring now to FIG. 12 which illustrates another alternative embodiment trapezoidal beam bridge 70′ consisting of the trapezoidal beam bridge 72′ and carriage 80′. The trapezoidal beam bridge 72′ includes carriages 80′, only one of which is illustrated. The carriage 80′ is provided for traveling along the parallel guide tracks 30 respectively, as described above in relation to FIGS. 7 and 8. The relationship and configuration of the carriage 80′ and the guide tracks 30 are substantially identical. Therefore, the following description, with reference to FIG. 12, in part, refers only to one carriage 80′. Additionally, the carriages 80′ can be motorized or provided with a motor and drive system.

The carriage 80′, or similar device, is movable along the parallel guide tracks 30 of the trapezoidal strong back beam system 70 and includes at least one mounting plate 82. The mounting plate 82 is configured to travel longitudinally along the parallel guide track 30 by way of rollers 84, 86, 88, 90, which are rotatably mounted to the mounting plate 82. The carriages 80′ bear the weight of the trapezoidal beam bridge 72′ and the crane (not illustrated), which is, in turn, borne by the parallel guide tracks 30. An additional mounting plate 82 may be used external of the profile (I-beam).

Preferably, the rollers 84, 86, 88, 90 include tapered surfaces thereby enabling the rollers 84, 86, 88, 90 to roll efficiently along the guide tracks 30. The rollers 84, 86, 88, 90 include plastic (or rubber) coated rolling surfaces. The plastic coated rolling surfaces are provided to reduce rolling noise of the rollers 84, 86, 88, 90. It is to be appreciated, however, that the rollers 84, 86, 88, 90 need not include plastic coated rolling surfaces. The rollers 84, 86, 88, 90 could instead include, for example, steel rolling surfaces.

The mounting plate 82 includes a safety mechanism in the form of anti-derailment means 82A, 82B. The anti-derailment means 82A, 82B are horizontally mounted wheels or similar, which ensure the carriages 80′ remain engaged with the guide tracks 30 of the trapezoidal strong back beam system 70. The anti-derailment means 82A, 82B are provided to prevent the trapezoidal beam bridge 72′ and crane crashing to the ground in the event of failure of the rollers 84, 86, 88, 90 or other parts of the carriage 80′.

The displacement arm 92 can be modified to accommodate the trapezoidal beam bridge 72′ therein. The displacement arm 92 is pivotally connected to a bridge sleeve 100, as illustrated in FIG. 12, which, in turn, is securely connected to the guide track 30 of the trapezoidal beam bridge 72′. The bridge sleeve 100 is constructed from steel. Any suitable grade steel, or any other material, could be used in the construction of the bridge sleeve 100. The displacement arm 92 is pivotally connected to the bridge sleeve 100 by two fasteners 102, 104 via displacement arm appendages 106, 108. The fasteners 102, 104 provide a pivotal connection between the displacement arm 92 and the bridge sleeve 100. A plurality of set screws 110 are used to secure the guide track 30 of the trapezoidal beam bridge 72′ to the bridge sleeve 100.

The trapezoidal beam bridge 72′ is adapted to receive the trolley 78 therein, with the trolley 78 being supported by the guide track 30 of the trapezoidal beam bridge 72′. The attachment means 76 of trolley 78 is thereby received within the opening 74 of the guide track 30 of the trapezoidal beam bridge 72′.

A hanger rod 112 pivotally connects the displacement arm 92 to the mounting plate 82, while a pair of cables 114 connect the displacement arm appendages 106, 108 to the mounting plate 82. The hanger rod 112 passes through the top of the displacement arm 92, a pivot post bearing 116, and a pivot nut 118. A rolling pin 120 supports the displacement arm 92 to the hanger rod 112.

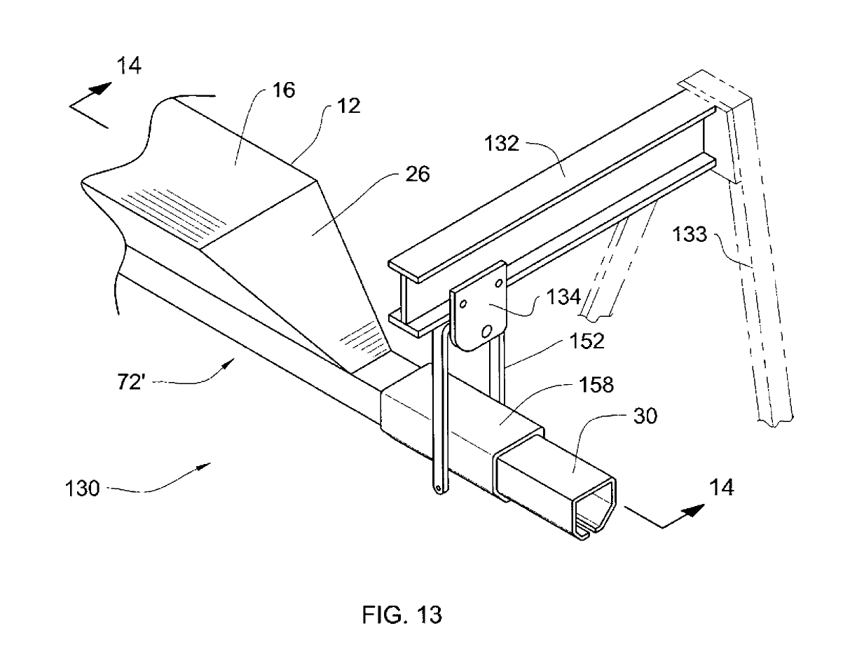

Referring now to FIGS. 13-15, which illustrate another alternative embodiment trapezoidal strong back beam system 130 consisting of the trapezoidal beam bridge 72′ and carriage 134 which is adapted to travel along parallel I-beams 132 respectively, only one of which is illustrated. The relationship and configuration of the carriage 134 and the I-beams 132 are substantially identical. Therefore, the following description, with reference to FIGS. 13-15, in part, refers only to one carriage 134. The I-beams 132 can be attached to a support structure or a surface (133).

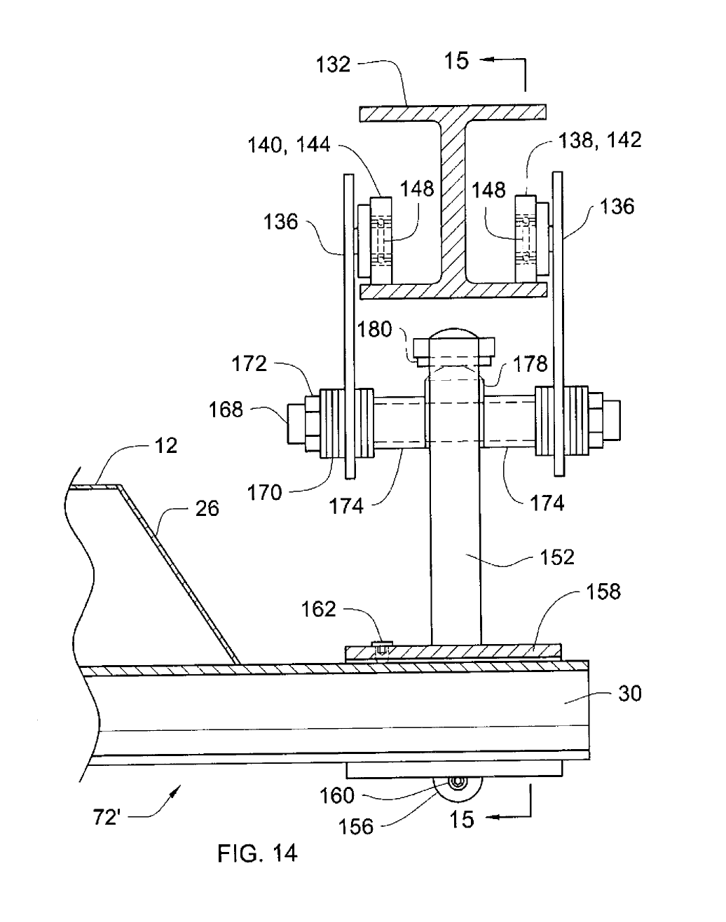

The carriage 134, or similar device, is movable along the I-beams 132 of the trapezoidal strong back beam system 130 and includes at least one mounting plate 136. FIG. 14 shows an embodiment comprising two mounting plates 136. The mounting plate 136 is configured to travel longitudinally along the parallel I-beam 132 by way of rollers 138, 140, 142, 144 which are rotatably mounted to the mounting plate 136. Rollers 138, 142 are positioned on one web of the I-beam 132, while the rollers 140, 144 are positioned on the other web of the I-beam 132, as best illustrated in FIG. 14. The carriages 134 bear the weight of the trapezoidal beam bridge 72′ and the crane (not illustrated), which is, in turn, borne by the I-beams 132. Additionally, the carriages 134 can be motorized or provided with a motor and drive system.

Preferably, the rollers 138, 140, 142, 144 include deep groove ball bearings 148 thereby enabling the rollers 138, 140, 142, 144 to roll efficiently along the I-beams 132. The rollers 138, 140, 142, 144 include plastic (or rubber) coated rolling surfaces. The plastic coated rolling surfaces are provided to reduce rolling noise of the rollers 138, 140, 142, 144. It is to be appreciated, however, that the rollers 138, 140, 142, 144 need not include plastic coated rolling surfaces. The rollers 138, 140, 142, 144 could instead include, for example, steel rolling surfaces.

The mounting plate 136 includes a safety mechanism in the form of anti-derailment pins 150. The anti-derailment pins 150 ensure the carriages 134 remain engaged with the I-beam 132 of the alternate embodiment trapezoidal strong back beam system 130. The anti-derailment pins 150 are provided to prevent the trapezoidal beam bridge 72′ and crane crashing to the ground in the event of failure of the rollers 138, 140, 142, 144 or other parts of the carriage 134.

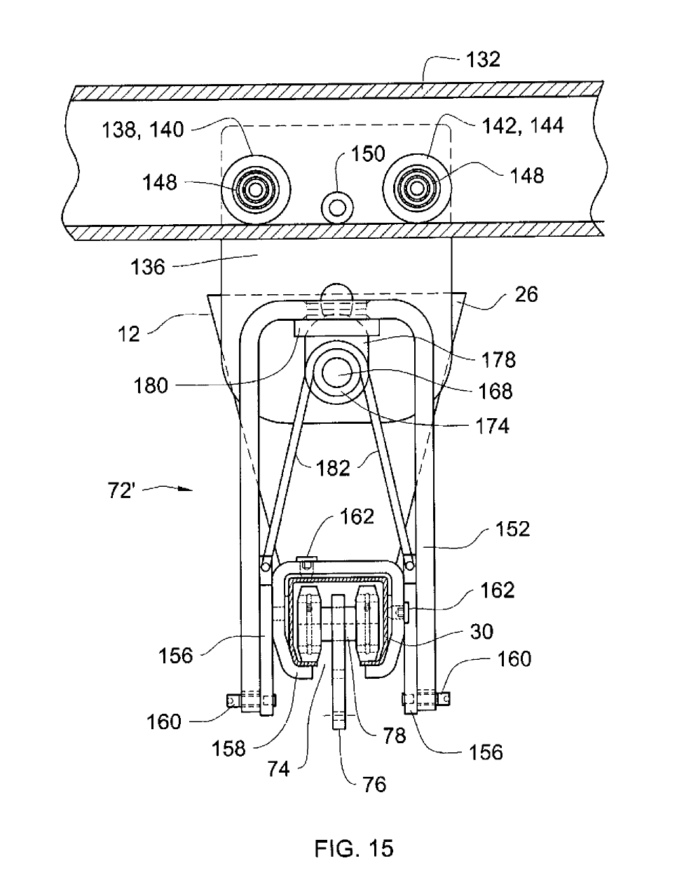

The displacement arm 152, which is in the configuration of a U-hanger, can be modified to accommodate the trapezoidal beam bridge 72′ therein. The displacement arm 152 is pivotally connected to a bridge sleeve or cross travel hanger plates 156, as best illustrated in FIGS. 14 and 15, which, in turn, is securely connected to a bridge sleeve or cross travel hanger 158. The bridge sleeve or cross travel hanger 158 is securely connected to the guide track 30 of the trapezoidal beam bridge 72′. The bridge sleeve or cross travel hanger 158 is constructed from steel. Any suitable grade steel, or any other material, could be used in the construction of the bridge sleeve or cross travel hanger 158. The displacement arm 152 is pivotally connected to the bridge sleeve or cross travel hanger 158 by two fasteners 160 via the bridge sleeve or cross travel hanger plates 156. The fasteners 106 provide a pivotal connection between the displacement arm 152 and the bridge sleeve or cross travel hanger 158. A plurality of set screws 162 is used to secure the guide track 30 of the trapezoidal beam bridge 72′ to the bridge sleeve or cross travel hanger 158.

The trapezoidal beam bridge 72′ is adapted to receive the trolley 78 therein, with the trolley 78 being supported by the guide track 30 of the trapezoidal beam bridge 72′. The attachment means 76 of trolley 78 thereby received within the opening 74 of the guide track 30 of the trapezoidal beam bridge 72′.

The displacement arm 152 is pivotally connected to the mounting plates 136 by way of a main axle 168. The main axle 168 passes through the mounting plates 136 and is pivotally secured to the mounting plates 136 by washers 170 and lock nuts 172. Main axle spacers 174 are positioned between the mounting plates 136 and a pivot post 178. The displacement arm 152 is pivotally connected to the pivot post 178 via a pivot post bearing 180. Additionally, cables 182 connect the travel hanger plates 156 to the main axle 168.

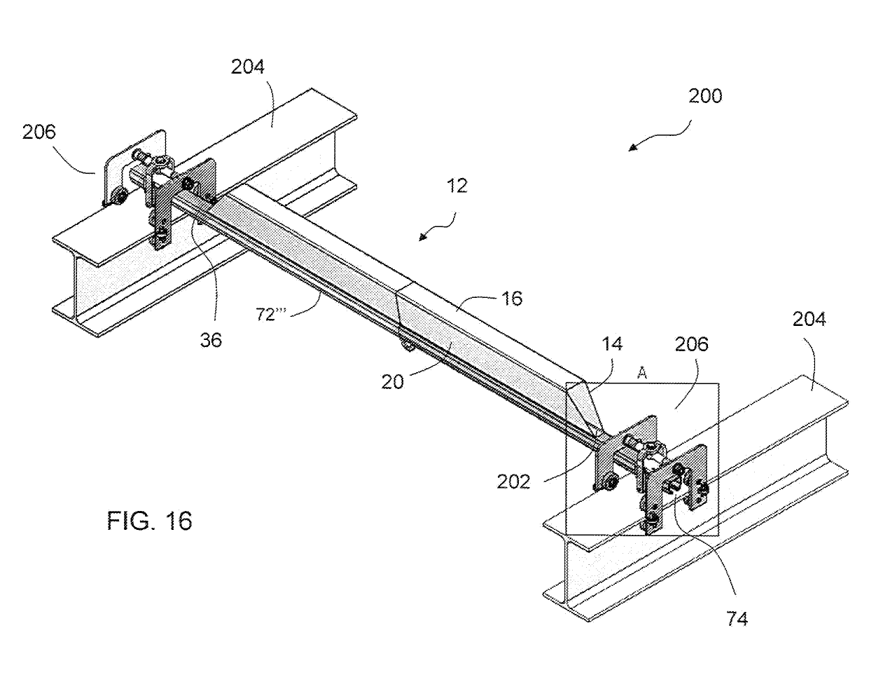

Referring now to FIG. 16, another embodiment of the present invention comprises a trapezoidal strong back beam system 200 comprising a trapezoidal beam 12 having a top section 16, an inwardly tapering first side 14 and an inwardly tapering second side 20 as described above in relation to other embodiments. A bottom section 202 opposite the top section 16 extends between the first and second sides 14, 20. A top portion 36 of the bridge 72″, which can have a similar configuration to the guide track 30 as described above, is secured to the bottom section 202 of the trapezoidal beam 12 by any suitable means known in the art, such as, but not limited to, welds along their flange seams, rivets, fasteners, adhesives, or clamps. As described above in relation to previous embodiments, bridge 72″ comprises an opening 74 through which attachment means 76 for a lifting device extends. The attachment means is connected to a trolley movable along the inside of the bridge 72″ as described above.

The embodiment shown in FIG. 16 comprises a pair of parallel, spaced apart guide tracks 204 having I-beam profiles, which provide external tracks for a top running trapezoidal strong back beam system. As illustrated in FIG. 16, the trapezoidal beam 12 extends substantially perpendicularly between, and is supported by, the parallel, spaced apart guide tracks 204 via respective carriages 206, or similar devices. The carriages 206 bear the weight of the trapezoidal beam 12 and the crane (not illustrated), which is, in turn, borne by the parallel guide tracks 204, thus forming a bridge crane.

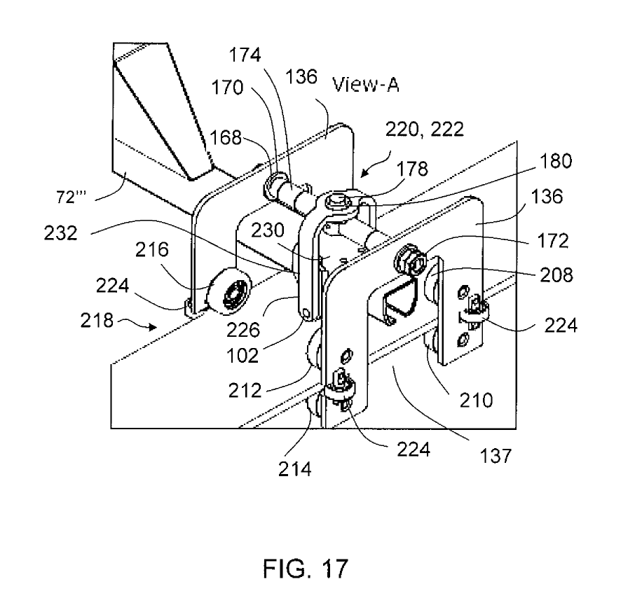

With reference to enlarged view in FIG. 17, each carriage 206 comprises at least one mounting plate 136. In this embodiment, each carriage 206 comprises a pair of spaced apart, substantially u-shaped mounting plates 136. At least one mounting plate 136, and in this embodiment both mounting plates 136, comprise(s) an opening 137 through which the bridge 72″ protrudes, as described in further detail below. Each carriage 206 is movable longitudinally along its respective guide track 204 by virtue of rollers 208, 210, 212, 214, 216, 218, 220, 222 rotatably mounted in a substantially vertical orientation to the mounting plates 136. Although rollers 218, 220, 222 are not visible in FIG. 17, the arrangement of the rollers is the same on each mounting plate 136. Rollers 208, 212, 216, 220 are positioned on one web of the I-beam of the guide track 204 and rollers 210, 214, 218, 222 are positioned underneath the web. Hence, each carriage 206 comprises four pairs of rollers, each pair having a roller above and below the web.

Each carriage 206 further comprises one or more end rollers 224 that abut and roll along the edge of the web of the I-beam. In the embodiment illustrated, a pair of end rollers 224 is rotatably mounted in a substantially horizontal orientation to each mounting plate 136.

The rollers 208, 210, 212, 214, 216, 218, 220, 222, 224 can include any one of the following as described above in relation to previous embodiments: deep groove ball bearings, plastic or rubber coated rolling surfaces, steel rolling surfaces.

The bridge 72″ is coupled to each carriage 206 via a displacement arm 226 and an elongate member in the form of a main axle 168 extending between and pivotally secured to the mounting plates 136. The displacement arm 226 is constructed from mild steel, or higher-grade steel, generally from steel plate or steel strip, but any other suitable material can be used. The displacement arm 226 is pivotally connected to a bridge sleeve 230, which receives and is securely connected to one end of the bridge 72″. The bridge sleeve 230 is constructed from any suitable grade steel, or any other suitable material. The displacement arm 226 is pivotally connected to the bridge sleeve 230 by fasteners 102 either side of the displacement arm 226 via displacement arm appendages 232. The fasteners 102 provide a pivotal connection between the displacement arm 92 and the bridge sleeve 230.

The main axle 168 is pivotally secured to each mounting plate 136 with washers 170 either side of the mounting plate 136 and locking nuts 172 on the outside of the mounting plates 136. Main axle spacers 174 are positioned between the mounting plates 136 and a pivot post 178 extending from the main axle 168. The displacement arm 226 is pivotally connected at the first end to the pivot post 178 via a pivot post bearing 180, which can be in the form of a lubricated plastic bush.

Appendages 232 give the displacement arm 226 a generally inverted U-shape configuration such that the first end is pivotally connected to the pivot post 178 and second ends of each appendage 232 pivotally connected to the bridge sleeve 230 by fasteners 102.

The above arrangement forms a universal joint that provides the necessary relative pivoting and lateral movement between the carriages 206 and the bridge 72″. The fluid motion of the arrangement avoids jamming, particularly upon initiating movement of the bridge 72″ forming the crane bridge relative to the parallel guide tracks 204 of the trapezoidal strong back beam system 200.

It is to be appreciated that the pivotal connection of the carriages 206 to the bridge 72″ could adopt configurations different to that specifically described above. The pivotal connection could instead, for example, include a rod end, or other pivotal or rotatable linkage arrangement.

In some alternative embodiments of the present invention, the carriages 206 can be replaced with the carriages disclosed in the Applicant's International patent application publication no. WO 03/101878 the contents of which are incorporated herein by reference.

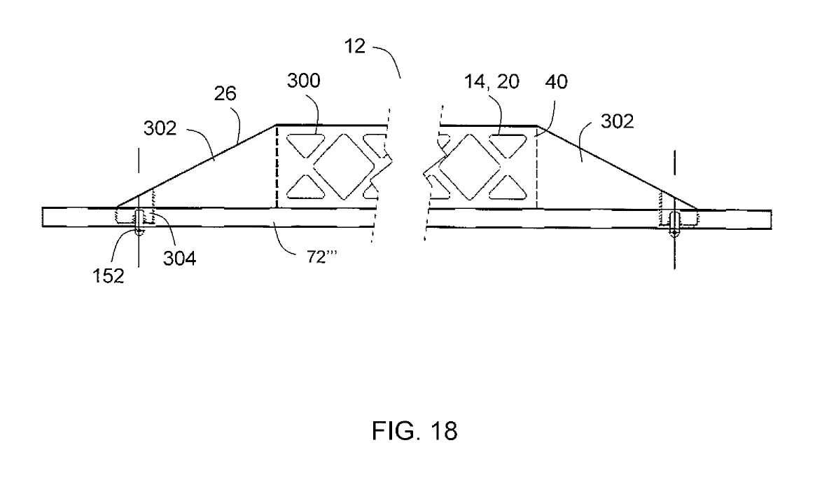

With reference to FIG. 18, according to some further alternative embodiments of the present invention, at least part of the first and second sides 14, 20 of the trapezoidal beam 12 comprise a lattice or cut-out structure 300 rather than solid sides as described in relation to previous embodiments herein. According to some embodiments, the majority of the first and second sides 14, 20, apart from solid ends 302, comprise the lattice structure 300, which allows for further reduction in the bridge weight whilst retaining sufficient strength. As described above in relation to previous embodiments, this embodiment comprises end caps 26 attached to the first and second sides 14, 20 above the bridge 72″ and diaphragm stiffeners 40 within the trapezoidal beam 12, which can also be provided adjacent vertical elements of the lattice structure 300.

As a yet further alternative to the embodiment shown in FIG. 18, the bridge 72″ is omitted and flat steel plates 304 are welded to and extend from the bottom section 202 of the trapezoidal beam 12 to provide a track. The trolley 78 comprising the displacement arm 152 depending therefrom as described above runs on the flat steel plates 304 forming the track instead of the bridge 72″′.

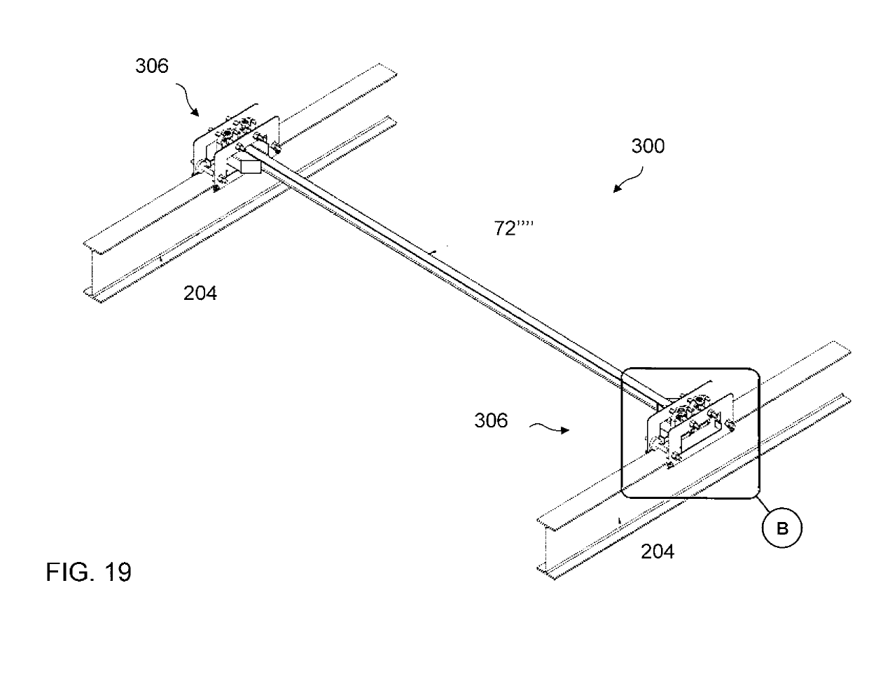

Referring now to FIGS. 19-21, another embodiment of the present invention comprises a lifting assembly 300 comprising a bridge 72″′, which can have a similar configuration to the guide track 30. As described above in relation to previous embodiments, bridge 72″′ comprises an opening 74 in an underside thereof through which attachment means 76 for a lifting device extends. The attachment means is connected to trolley 78 (shown in FIG. 7) movable along the inside of the bridge 72″′ as described above.

The embodiment shown in FIGS. 19-21 comprises a pair of parallel, spaced apart guide tracks 204 having I-beam profiles, which provide external tracks for a top running bridge crane. As illustrated in FIGS. 19-21, the bridge 72″′ extends substantially perpendicularly between, and is supported by, the parallel, spaced apart guide tracks 204 via respective carriages 306, or similar devices. The carriages 306 bear the weight of the bridge 72″′ and the crane (not illustrated), which is, in turn, borne by the parallel guide tracks 204, thus forming a bridge crane.

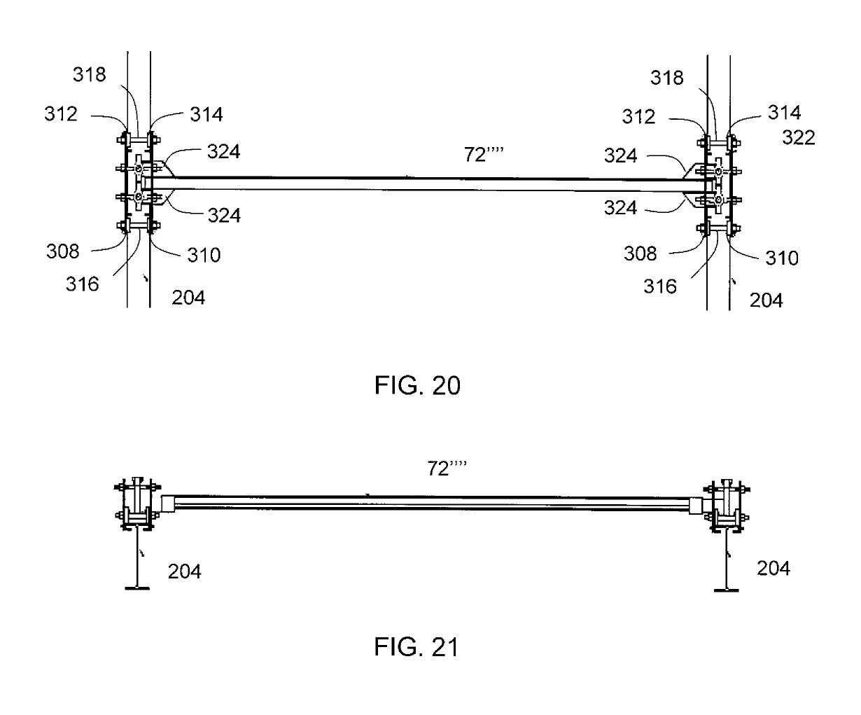

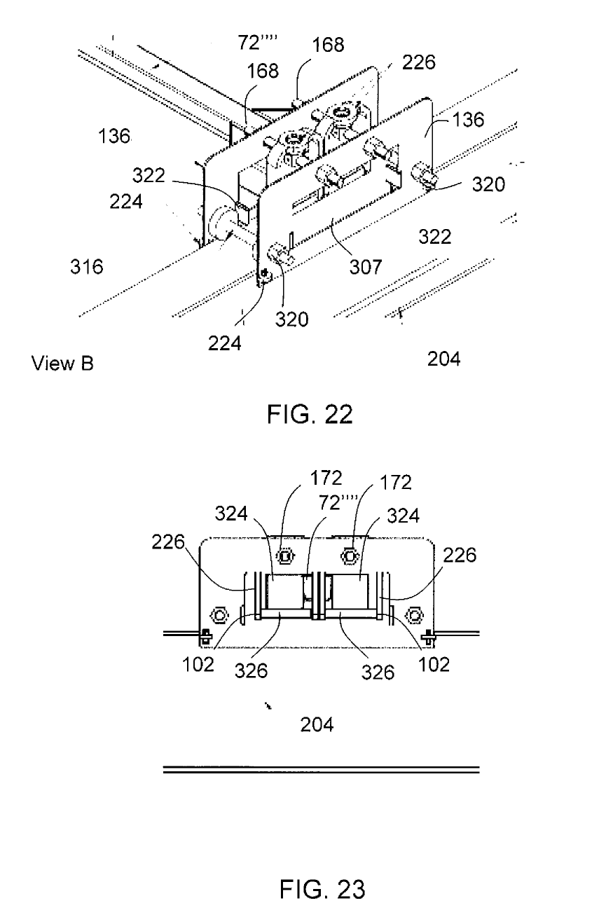

With additional reference to the enlarged views in FIGS. 22 and 23, each carriage 306 comprises at least one mounting plate 136. In this embodiment, each carriage 306 comprises a pair of spaced apart, substantially rectangular mounting plates 136 each having an aperture 307 therethrough. Each carriage 306 is movable longitudinally along its respective guide track 204 by virtue of rollers 308, 310, 312, 314, rotatably mounted in a substantially vertical orientation to the mounting plates 136 via respective shafts 316, 318. This arrangement is most clearly shown in FIG. 20. Shafts 316, 318 can be in the form of threaded bolts passing through apertures in the mounting plates 136 and secured in place with bolts 320. Bolts and/or spacers can be used to maintain the position of the rollers 308, 310, 312, 314 along the respective shafts 316, 318. Rollers 308, 310, 312, 314 are positioned on one web of the I-beam of the guide track 204. Each carriage 306 comprises projections 322 extending inwardly from the mounting plates 136 adjacent the rollers 308, 310, 312, 314. Projections 322 extend inwardly above one web of the I-beam of the guide track 204 and act as anti-derailment plates to prevent derailment of the rollers 308, 310, 312, 314 and therefore the carriages 306 from the guide track 204.

Each carriage 306 further comprises one or more guide rollers 224 that abut and roll along the edge of the web of the I-beam. In the embodiment illustrated, a pair of guide rollers 224 is rotatably mounted in a substantially horizontal orientation to each mounting plate 136 with a guide roller 224 at each end of the mounting plate 136.

The rollers 308, 310, 312, 314 and guide rollers 224 can include any one of the following as described above in relation to previous embodiments: deep groove ball bearings, plastic or rubber coated rolling surfaces, steel rolling surfaces.

The bridge 72″′ is coupled to each carriage 306 via a pair of displacement arms 226 pivotally secured to a respective elongate member in the form of a main axle 168 extending between the mounting plates 136. The displacement arms 226 are constructed from mild steel, or higher-grade steel, generally from steel plate or steel strip, but any other suitable material can be used. Each displacement arm 226 is pivotally connected to the bridge 72″′ via a shoulder 324 securely connected to one end of the bridge 72″′. A pair of shoulders 324 are, for example, welded in a parallel arrangement to each side of the bridge 72″′ at the end thereof as shown in FIGS. 19-23. As shown in FIG. 23, each shoulder 324 comprises a support in the form of an anti-drop plate 326 welded to an underside of each shoulder 324. Each support 326 comprises an aperture in each end thereof for receiving a fastener 102 in the form of a rod. Each displacement arm 226 is pivotally connected to a respective shoulder 324 by fasteners 102 extending through either side of the displacement arm 226 and into the apertures in each end of support 326. The fasteners 102 provide a pivotal connection between the displacement arm 226 and the shoulders 324 of the bridge 72″′. According to some embodiments, the apertures extend through the length of the support 326 and a pair of rods are used such that a single rod passes through each displacement arm 226 and respective support 326.

The main axles 168 can be in the form of threaded bolts and are secured to each mounting plate 136 with washers 170 either side of the mounting plate 136 and locking nuts 172 on the inside and outside of the mounting plates 136, as described above in relation to earlier embodiments. Only locking nuts 172 on the outside of the mounting plates 136 are shown in FIGS. 19-23. Although not shown in FIGS. 19-23, as described previously herein, (with reference to, for example, FIG. 14), according to some embodiments, main axle spacers 174 can be positioned between the mounting plates 136 and a respective pivot post 178. The displacement arms 226 are pivotally connected to respective pivot posts 178 via a pivot post bearing 180, which can be in the form of a lubricated plastic bush.

The above arrangement forms a universal joint that provides the necessary relative pivoting and lateral movement between the carriages 306 and the bridge 72″′. The fluid motion of the arrangement avoids jamming, particularly upon initiating movement of the bridge 72″′ forming the crane bridge relative to the parallel guide tracks 204 of the lifting assembly 300. Aperture 307 through each mounting plate 136 allows sufficient movement of the guide track 30 and shoulders 324. Shoulders 324 provide for attachment to the pair of displacement arms 226 and the space between the shoulders 324 allows for fitting of the trolley 78 to the bridge 72″′.

It is to be appreciated that the pivotal connection of the carriages 306 to the bridge 72″′ could adopt configurations different to that specifically described above. The pivotal connection could instead, for example, include a rod end, or other pivotal or rotatable linkage arrangement.

Although the embodiments shown in FIGS. 19-23 show a plain bridge 72″′, the aforementioned trapezoidal strong back beam system can be used with the embodiments shown in FIGS. 19-23.

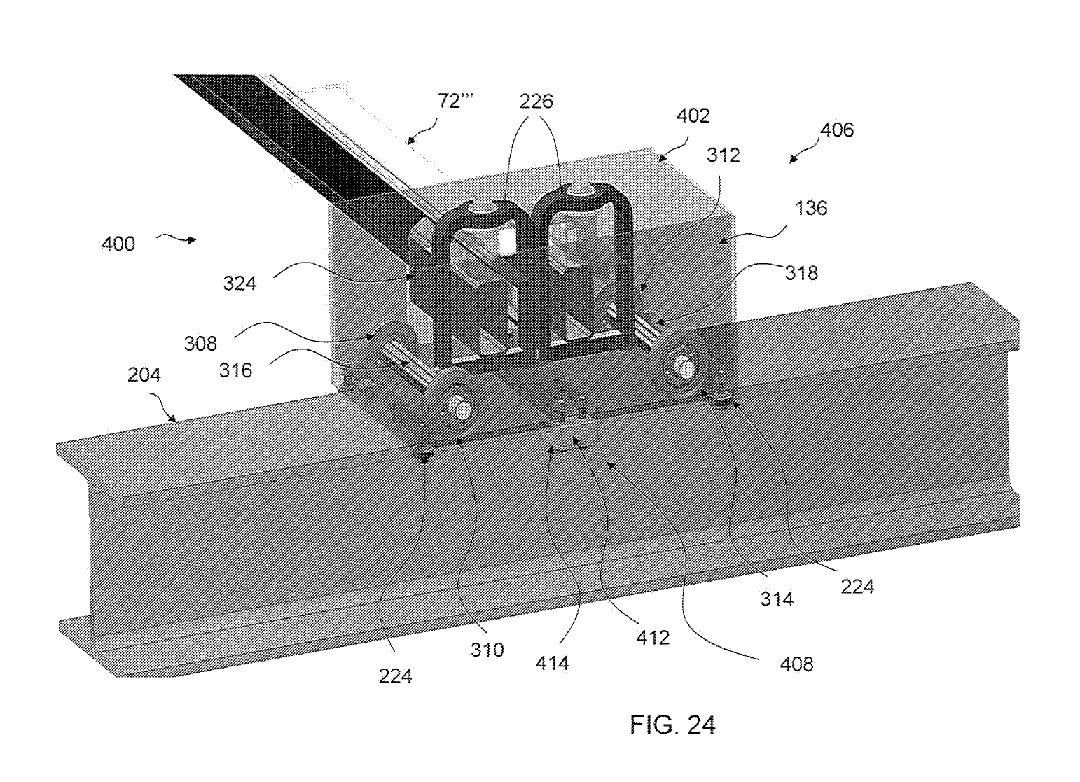

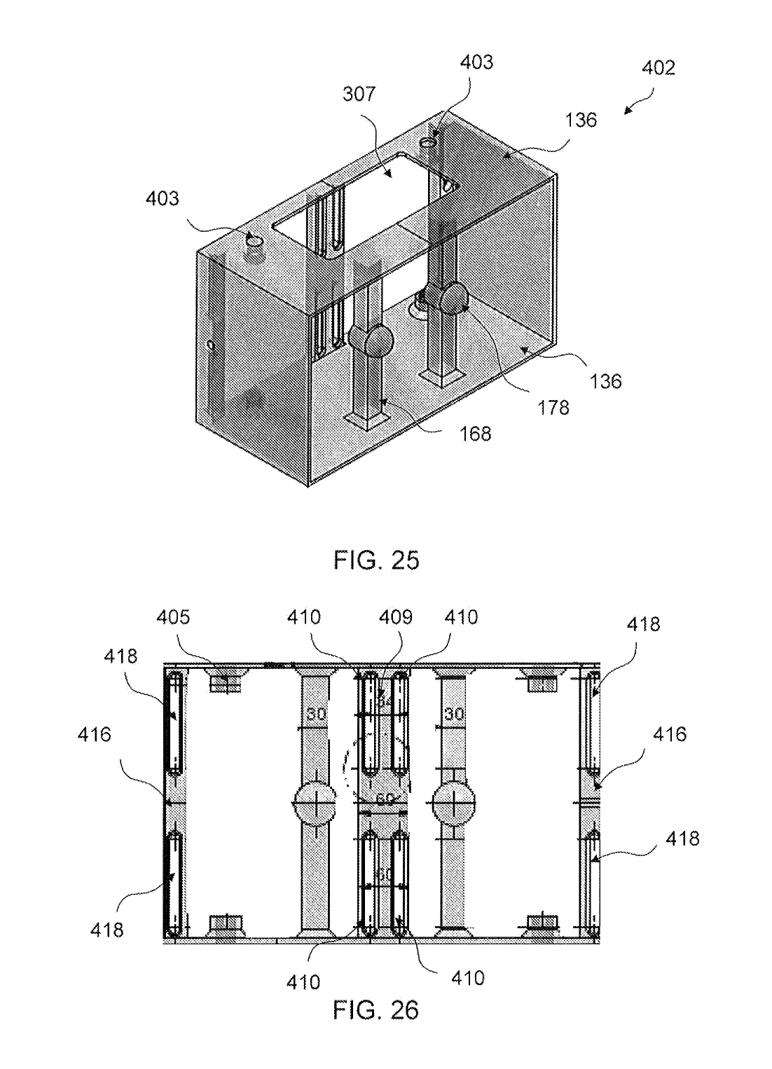

A further variation to the embodiments shown in FIGS. 19-23 is shown in FIGS. 24-26. In this embodiment, the lifting assembly 400 comprises a bridge 72″′ having a pair of shoulders 324 provided at each end for pivotal coupling to respective displacement arms 226 of a respective carriage 406 as described above. However, in this embodiment, the mounting plates 136 form two walls of a cast box 402, which can be cast from any suitable metal, such as high tensile steel grade 4140. In this embodiment, one of the mounting plates 136 on a side closest the bridge 72″′ comprises an aperture 307 through which the bridge 72″′ protrudes to allow pivotal connection of the shoulders 324 to the displacement arms 226. The mounting plate 136 on the outside is a plain wall and does not comprise an aperture.

Elongate members 168, comprising pivot posts 178, have a square cross section and are cast with the box 402. Elongate members 168 may however have other cross sectional shapes. Therefore, elongate members 168 are fixed rather than in the form of pivoting main axles as described above in relation to the embodiments shown in FIGS. 16, 17 and 19-23.

Each carriage 406 is movable longitudinally along its respective guide track 204 by virtue of rollers 308, 310, 312, 314, rotatably mounted in a substantially vertical orientation to the mounting plates 136 via respective shafts 316, 318 as described above. Mounting plates 136 on either side of the cast box 402 comprise apertures 403 and collars 405 for mounting shafts 316, 318.

Each carriage 406 comprises at least one anti-derailment member 408 and in this embodiment a pair of anti-derailment members 408 are mounted to an underside of the cast box 402 beneath mounting plates 136 on either side of the cast box 402. Box 402 is cast with a first base member 409 in a substantially central position comprising a plurality of elongate apertures 410. In this embodiment, four elongate apertures 410 are provided and anti-derailment members 408 are fixed to first base member 409 with fasteners, such as nuts and bolts. Anti-derailment members 408 comprise a block 412 that abuts or runs very close to the web of the I-beam of the guide track 204 and a plate 414 attached to the block 412 by the fasteners that is positioned beneath the web of the I-beam to prevent derailment of the rollers 308, 310, 312, 314 and therefore the carriage 406 from the guide track 204. Elongate apertures 410 allow accurate positioning and variable mounting of the anti-derailment members 408 with respect to the guide track 204 and enable the carriage 406 to be used with a wide range of guide tracks of different sizes and shapes.

Each carriage 406 further comprises one or more guide rollers 224 that abut and roll along the edge of the web of the I-beam. In the embodiment illustrated, a pair of guide rollers 224 is rotatably mounted in a substantially horizontal orientation to a respective end base member 416 of the cast box 402 with fasteners, such as nuts and bolts. Each base member 416 comprises a pair of elongate apertures 418 to allow accurate positioning and variable mounting of the guide rollers 224.

The embodiment shown in FIGS. 24-26 has superior strength than some of the previous embodiments and is cheaper to produce because it is cast as a single unit rather than being formed from separately cut and machined components.

It is to be appreciated that part(s) of the above-described arrangements could be incorporated into existing assemblies. In this respect, the Applicant envisages that the arrangements illustrated in FIGS. 7-26 in their entirety or in part, could be incorporated into existing assemblies. The Applicant envisages that at least the arrangements comprising top running carriages described herein can be motorized rather than moved by hand.

The alternative embodiment trapezoidal strong back beam systems 10, 50, 70, 70′, 130, 200 allow for the bridge weight to be reduced by approximately 35% compared with using RHS beams as a strong back beam.

Furthermore, without the use of the trapezoidal strong back beams 10, 50, 70, 70′, 130, 200, a current 1 tonne 12 metre bridge design weighs 513 kg. Using the trapezoidal strong back beams 10, 50, 70, 70′, 130, 200 according to embodiments of the invention, a 2 tonne 12 metre bridge design weighs 440 kg. Embodiments of the present invention also allow bridge lengths of up to at least 15 metres for manual bridge cranes and considerably longer bridge lengths for motorized bridge cranes. The benefit of using the trapezoidal strong back beam 10, 50, 70, 70′, 130, 200 according to embodiments of the invention on bridge cranes can thus be appreciated.

The alternative embodiment trapezoidal strong back beam systems 10, 50, 70, 70′, 130, 200 and lifting assemblies 300, 400 of the present invention have been found to at least reduce the incidence of jamming experienced by existing assemblies. This applies to both the manually operated and motorized versions. Additionally, alternative embodiment trapezoidal strong back beam systems 10, 50, 70, 70′, 130, 200 and lifting assemblies 300, 400 of the present invention have also been found to require less operator effort to initiate movement of the bridge 72, 72′, 72″, 72″′ along the parallel beams 10, 50, 132 when compared to existing assemblies. The assemblies 200, 300, 400 in particular also provide more head room in comparison with some of the existing assemblies.

Moreover, the present invention is particularly useful, because it can be relatively easily incorporated into existing assemblies.

While preferred embodiments of the trapezoidal strong back beam system have been described in detail, it should be apparent that modifications and variations thereto are possible, which will fall within the scope of the invention. With respect to the above description, it is to be realized that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described and accordingly, all suitable modifications and equivalents that may be resorted to, fall within the scope of the invention.

1. A carriage for a bridge crane assembly, the carriage comprising:
a pair of spaced apart mounting plates, at least one of the mounting plates comprising an aperture;
a plurality of rollers rotatably mounted in a substantially vertical orientation to the mounting plates for longitudinal movement of the carriage along a respective guide track of the bridge crane assembly;
an elongate member extending between the mounting plates; and
a displacement arm pivotally coupled at a first end to the elongate member, the displacement arm having at least one second end for pivotal connection to a bridge, the bridge protruding through the aperture in at least one of the mounting plates and comprising an attachment means for supporting a lifting device of the bridge crane assembly.

2. The carriage of claim 1, wherein the displacement arm is pivotally coupled to a pivot post via a pivot post bearing, the pivot post extending from the elongate member.

3. The carriage of claim 1, wherein the elongate member is an axle pivotally secured to the mounting plates.

4. The carriage of claim 1, wherein the displacement arm is pivotally connected to a bridge sleeve for receiving one end of the bridge.

5. The carriage of claim 4, wherein the displacement arm comprises a pair of appendages, each appendage pivotally connected to the bridge sleeve by a fastener.

6. (canceled)

7. The carriage of claim 1, wherein the carriage moves on top of the respective guide track.

8. The carriage of claim 1, wherein the respective guide track is in the form of an I-beam and the carriage moves on top of one web of the I-beam.

9. The carriage of claim 8, wherein some of the plurality of rollers are positioned on top of one web of the I-beam and some of the plurality of rollers are positioned underneath the web.

10. The carriage of claim 8, further comprising one or more end rollers, each end roller abutting and capable of rolling along a respective edge of the web of the I-beam.

11. The carriage of claim 10, wherein a pair of end rollers is rotatably mounted in a substantially horizontal orientation to each mounting plate.

12. The carriage of claim 1, further comprising:
a second elongate member spaced apart from the elongate member, the second elongate member extending between the mounting plates; and
a second displacement arm pivotally coupled at a first end to the second elongate member, the displacement arm having at least one second end for pivotal connection to the bridge.

13. The carriage of claim 12, wherein the second elongate member is an axle pivotally secured to the mounting plates.

14. The carriage of claim 12, further comprising a shoulder either side of the bridge at the end of the bridge, each shoulder pivotally connected to a respective displacement arm.

15. The carriage of claim 14, further comprising a support on the underside of each shoulder for receiving a pair of fasteners for pivotal connection to a respective displacement arm.

16. The carriage of claim 12, further comprising projections extending inwardly from the mounting plates adjacent the rollers to prevent derailment of the rollers from the guide track.

17. The carriage of claim 12, wherein the mounting plates and the first and second elongate members form part of a cast box.

18. The carriage of claim 17, further comprising a first base member for mounting at least one anti-derailment member.

19. The carriage of claim 18, wherein the first base member comprises a plurality of elongate apertures for variable mounting of the at least one anti-derailment member.

20. The carriage of claim 17, further comprising at least one end base member for mounting one or more end rollers, each end roller abutting and capable of rolling along a respective edge of a web of an I-beam of the respective guide track.

21. The carriage of claim 20, wherein the at least one end base member comprises a plurality of elongate apertures for variable mounting of the one or more end rollers.

22. A bridge crane assembly comprising:
a trapezoidal beam;
a bridge attached to an underside of the trapezoidal beam;
at least one guide track attachable to a support structure; and
at least one carriage longitudinally movable along the at least one guide track, the carriage including:
a pair of spaced apart mounting plates, at least one of the mounting plates comprising an aperture;
a plurality of rollers rotatably mounted in a substantially vertical orientation to the mounting plates for longitudinal movement of the carriage along a respective guide track of the bridge crane assembly;
an elongate member extending between the mounting plates; and
a displacement arm pivotally coupled at a first end to the elongate member, the displacement arm having at least one second end for pivotal connection to the bridge, the bridge protruding through the aperture in at least one of the mounting plates and comprising an attachment means for supporting a lifting device of the bridge crane assembly.

23. (canceled)

24. (canceled)

25. The bridge crane assembly of claim 22 at least part of a first side of the trapezoidal beam and/or at least part of a second side of the trapezoidal beam comprises a lattice structure.

26. The bridge crane assembly of claim 22, wherein the at least one carriage is top running or under slung with respect to the guide track.

27. (canceled)

28. (canceled)

29. (canceled)

30. A bridge crane assembly comprising:
a trapezoidal beam;
at least one guide track attachable to an underside of the trapezoidal beam;
at least one carriage longitudinally movable within the at least one guide track;
a bridge comprising an attachment means for supporting a lifting device;
at least one displacement arm having a first end pivotally connected to the at least one carriage and at least one second end pivotally connected to a bridge; and
a universal joint provided between the at least one displacement arm and the at least one carriage to absorb rotational and lateral motions of the bridge when a force is applied to the attachment means.

31. The bridge crane assembly of claim 30, wherein the at least one carriage is top running or under slung with respect to the guide track.

32. (canceled)

33. (canceled)

34. A bridge crane assembly comprising:
a bridge having an attachment means for supporting a lifting device;
at least one guide track attachable to a support structure; and
at least one carriage as claimed in claim 1 longitudinally movable along the at least one guide track.

35. A carriage for a bridge crane assembly, the carriage comprising:
a body;
a plurality of rollers rotatably mounted in a substantially vertical orientation to the body for longitudinal movement of the carriage along a respective guide track of the bridge crane assembly;
an elongate member supported by the body; and
at least one displacement arm slidably and rotatably coupled at a first end to the elongate member, the at least one displacement arm having at least one second end for pivotal connection to a bridge, the bridge comprising an attachment means for supporting a lifting device of the bridge crane assembly.

36. The carriage of claim 35, wherein the at least one displacement arm is in the form of a stirrup comprising an aperture at the first end for slidably and rotatably receiving the elongate member.

37. The carriage of claim 36, wherein the aperture comprises a spherical bearing.

38. The carriage of claim 35, further comprising at least one biasing means slidably mounted on the elongate member adjacent the first end of the at least one displacement arm.

39. The carriage of claim 38, further comprising at least one spacer slidably mounted on the elongate member between the biasing means and the body.

40. The carriage of claim 35, wherein the at least one displacement arm is pivotally connected to the bridge at the second end via a pivot post and a pivot post bearing.

41. The carriage of claim 35, further comprising a shoulder either side of the bridge at the end of the bridge, each shoulder pivotally connected to a respective displacement arm in the form of a stirrup.

42. A bridge crane assembly comprising:
a pair of spaced apart guide tracks attachable to a support structure; and
a pair of carriages as claimed in claim 35, each carriage longitudinally movable along a respective guide track.

43. The bridge crane assembly of claim 42, further comprising a synchronized drive means coupled to a shaft of each carriage via a gearbox, the shaft comprising a plurality of rollers.

44. (canceled)
